(19) United States
(12) Patent Application Publication
(10) Pub. No.: US 2024/0429692 A1
(43) Pub. Date: Dec. 26, 2024

(54) FIRE RATED DRILL PATTERN FOR WEATHERPROOF JUNCTION BOX

(71) Applicant: Easy Solar Products, Inc., Holladay, UT (US)

(72) Inventors: Alexander Bornemann, Duxbury, VT (US); Benjamin Wade, Holladay, UT (US); Brady Schimpf, Eagle Point, OR (US)

(21) Appl. No.: 18/766,640

(22) Filed: Jul. 8, 2024

Related U.S. Application Data
(63) Continuation-in-part of application No. 18/737,100, filed on Jun. 7, 2024.
Application No. 18/737,100 is a continuation of application No. 18/212,669, filed on Jun. 21, 2023.
(60) Provisional application No. 63/525,240, filed on Jul. 6, 2023.

(51) Int. Cl. H02G 3/08; H02G 3/10; H02G 3/14; H02G 3/22

(52) U.S. Cl. CPC H02G 3/081; H02G 3/088; H02G 3/10; H02G 3/14; H02G 3/22

(57) ABSTRACT

An improved weatherproof junction box includes a housing that includes a plurality of sides and a bottom. The plurality of sides and the bottom include a housing material. The housing material fabricated from a non-metallic material. The junction box includes a drill pattern in a side of the plurality of side and/or the bottom. The drill pattern includes a recess indicating a location for creating a hole through the housing. A thickness of the housing material under the drill pattern is sized to meet a fire rating standard applicable to a location where the junction box is installed.

### CROSS-REFERENCES TO RELATED APPLICATIONS

This application claims the benefit of U.S. Provisional Patent Application No. 63/525,240 entitled “Improved Weatherproof Junction Box” and filed on Jul. 6, 2023 for Alexander Bornemann, which is incorporated herein by reference.

### FIELD

This invention relates to junction boxes and more particularly relates to weatherproof junction boxes with weatherproofing sealant protecting roof penetrations.

### BACKGROUND

Junction boxes and other equipment are often mounted on the exterior of a building or other structure where it is desirable to prevent moisture from entering an area under the junction boxes or other devices. The area under a junction box or other device mounted to a structure often include fasteners penetrating the structure and may include holes for wiring, cables, piping, etc.

### SUMMARY

An improved weatherproof junction box includes a housing that includes a plurality of sides and a bottom. The plurality of sides and the bottom include a housing material. The housing material fabricated from a non-metallic material. The junction box includes a drill pattern in a side of the plurality of side and/or the bottom. The drill pattern includes a recess indicating a location for creating a hole through the housing. A thickness of the housing material under the drill pattern is sized to meet a fire rating standard applicable to a location where the junction box is installed.

Another improved weatherproof junction box includes a housing that includes a plurality of sides and a bottom. The plurality of sides and the bottom include a housing material. The housing material is fabricated from a non-metallic material. The junction box includes one or more drill patterns in a side of the plurality of side and/or the bottom. Each of the one or more drill patterns includes a recess indicating a location for creating a hole through the housing. The junction box includes a drill zone marking on a side of the plurality of sides and/or the bottom surrounding the one or more drill patterns. The drill zone marking is indicative of locations on the side of the plurality of sides and/or the bottom suitable for penetrating the housing. A thickness of the housing material under the one or more drill patterns is sized to meet a fire rating standard applicable to a location where the junction box is installed.

Another improved weatherproof junction box includes a housing that includes a plurality of sides and a bottom. The plurality of sides and the bottom includes a housing material. The housing material is fabricated from a non-metallic material and the housing is configured to mount to a sloped roof of a structure. The junction box includes one or more first drill patterns in a side of the plurality of side and/or the bottom. Each of the one or more drill patterns includes a first recess indicating a location for creating a hole through the housing. The junction box includes one or more second drill patterns positioned on a side of the housing opposite the one or more first drill patterns. The one or more second drill patterns each include a second recess indicating a location for creating a hole through the housing. Each of the one or more second recesses is aligned with a corresponding first recess. The junction box includes a drill zone marking on a side of the plurality of sides and/or the bottom surrounding the one or more drill patterns. The drill zone marking are indicative of locations on the side of the plurality of sides and/or the bottom suitable for penetrating the housing. The junction box includes flashing extending along a plane parallel to an exterior side of the bottom in a direction away from the housing. A thickness of the housing material between each of the first recesses and the corresponding second recesses is sized to meet a fire rating standard applicable to a location where the junction box is installed.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a side perspective view illustrating a junction box with flashing with a lid attached, according to various embodiments;

FIG. 1B is another side perspective view illustrating the junction box of FIG. 1A with the lid attached, according to various embodiments;

FIG. 1C is another side perspective view illustrating the junction box of FIG. 1A with the lid removed, according to various embodiments;

FIG. 1D is a rear view of the junction box of FIG. 1A in an unmounted condition, according to various embodiments;

FIG. 1E is a side view of the junction box of FIG. 1A in an unmounted condition, according to various embodiments;

FIG. 1F is a rear view of the junction box of FIG. 1A in a mounted condition, according to various embodiments;

FIG. 1G is a side view of the junction box of FIG. 1A in a mounted condition, according to various embodiments;

FIG. 1H is a bottom view and a section view of the junction box of FIG. 1A in an unmounted condition, according to various embodiments;

FIG. 1I is a bottom view and a section view of the junction box of FIG. 1A in a mounted condition, according to various embodiments;

FIG. 1J is a perspective view of the junction box of FIG. 1A prior to mounting on a roof with shingles, according to various embodiments;

FIG. 1K is a perspective view of the junction box of FIG. 1A prior to mounting on a roof with shingles with screws, according to various embodiments;

FIG. 1L is a perspective view of the junction box of FIG. 1A in a mounted condition on a roof with shingles where the lid is removed, according to various embodiments;

FIG. 1M is a perspective view of the junction box of FIG. 1A in a mounted condition on a roof with shingles where the lid attached, according to various embodiments;

FIG. 1N is a side view of the junction box of FIG. 1A in an unmounted condition on a roof with shingles, according to various embodiments;

FIG. 1O is a side view of the junction box of FIG. 1A in a mounted condition on a roof with shingles, according to various embodiments;

FIG. 1P is a top view, a bottom view, and a front view of the junction box of FIG. 1A, according to various embodiments;

FIG. 2A includes two perspective views illustrating a junction box without flashing without a lid, and a sealant configured to be mounted between a bottom of the junction box and a structure, according to various embodiments;

FIG. 2B is a top view, a side view, a bottom view, a rear view, a section view, and a detailed section view of the junction box of FIG. 2A, according to various embodiments;

FIG. 3 is a perspective view of a portion of a bottom or a side of a junction box described herein with a drill pattern, a side view of the bottom, a section view of the bottom, a hole saw bit of a drill prior to drilling and during drilling where the hole saw bit is aligned with the drill pattern, according to various embodiments;

FIG. 4 is a perspective view of a portion of a bottom or a side of a junction box described herein with an alternate drill pattern, a side view of the bottom, a section view of the bottom, a step drill bit of a drill prior to drilling and during drilling where the step drill bit is aligned with the alternate drill pattern, according to various embodiments;

FIG. 5 is a perspective view of a portion of a bottom or a side of a junction box described herein with the alternate drill pattern of FIG. 4, a side view of the bottom, a section view of the bottom, a hole saw bit of a drill prior to drilling and during drilling where the hole saw bit is aligned with the alternate drill pattern, according to various embodiments;

FIG. 6 is a perspective view of a portion of a bottom or a side of a junction box described herein with an third drill pattern with a thinned section, a side view of the bottom, a section view of the bottom, a step drill bit of a drill prior to drilling and during drilling where the step drill bit is aligned with the third drill pattern, according to various embodiments;

FIG. 7 is a perspective view of a portion of a bottom or a side of a junction box described herein with a hole drilled therein and a conduit connector just prior to and after connection of the connector in the hole, according to various embodiments;

FIG. 8A is a perspective view of a junction box with flashing without a lid attached with the junction box mounted to a shingled roof, according to various embodiments;

FIG. 8B is a top view while mounted and a side section view while mounted of the junction box of FIG. 8A, according to various embodiments;

FIG. 8C is a top view, a side view with an upper sealant installed, and a side view with the sealant removed of the junction box of FIG. 8A, according to various embodiments;

FIG. 8D is a top perspective view of the junction box of FIG. 8A with the upper sealant removed, according to various embodiments;

FIG. 9A is a perspective view of a junction box with a plate and attachment screws to be inserted from a top of the junction box where the box has a flashing, according to various embodiments;

FIG. 9B is a bottom perspective view of the junction box of FIG. 9A, according to various embodiments;

FIG. 10 is a bottom perspective view of a bottom of a junction box described herein with a drill zone, according to various embodiments;

FIG. 11 is a perspective view of the junction box of FIG. 1A with conduit and conduit connectors installed at an upper level and at a lower level of the junction box, according to various embodiments;

FIG. 12 is a perspective view of the junction box of FIG. 2A with conduit and conduit connectors installed at an upper level and at a lower level of the junction box, according to various embodiments;

FIG. 13A is a top perspective view of a junction box without side flashing and a perspective view of a sealant to be mounted to the bottom of the junction box, according to various embodiments;

FIG. 13B is a bottom perspective view of the junction box of FIG. 13A with the sealant installed, according to various embodiments;

FIG. 13C is a bottom perspective view of the junction box of FIG. 13A with the sealant and screws installed, according to various embodiments;

FIG. 13D is a bottom perspective view of the junction box of FIG. 13A with the sealant and screws installed where the sealant is flattened against a structure, according to various embodiments;

FIG. 13E is a side view and a side section view of the junction box of FIG. 13A with the sealant and screws installed where the sealant is flattened against a structure, according to various embodiments;

FIG. 14 is a top perspective view of a junction box with side flashing and a perspective view of a sealant to be mounted to the bottom of the junction box, according to various embodiments;

FIG. 15 is an exploded side perspective view of a step drill bit and a depth guide, a side perspective view of the step drill bit with the depth guide in a first position, and a side perspective view of the step drill bit with the depth guide in a second position, according to various embodiments;

FIG. 16A is a top perspective view of a junction box with full bottom plate installed, a top perspective view of the junction box with the full bottom plate removed, and a bottom perspective view of the junction box with the full bottom plate removed, according to various embodiments;

FIG. 16B is a top view, a side view, a section view, and a rear view of the junction box of FIG. 16A, according to various embodiments;

FIG. 16C is a top view, a side exploded view, a section exploded view, and a rear exploded view of the junction box of FIG. 16A, according to various embodiments;

FIG. 17A is a top perspective view of a junction box with an interior plate installed in the junction box, a top perspective view of the junction box with the interior plate removed, and a bottom perspective view of the junction box with the interior plate removed, according to various embodiments;

FIG. 17B is a top view, a side view, a section view, and a rear view of the junction box of FIG. 17A, according to various embodiments;

FIG. 17C is a top view, a side exploded view, a section exploded view, and a rear exploded view of the junction box of FIG. 17A, according to various embodiments;

FIG. 18A is a top perspective view of a junction box with partial bottom plate installed in a cavity of the bottom of the junction box, a top perspective view of the junction box with the partial bottom plate removed, and a bottom perspective view of the junction box with the partial bottom plate removed, according to various embodiments;

FIG. 18B is a top view, a side view, a section view, and a rear view of the junction box of FIG. 18A, according to various embodiments; and

FIG. 18C is a top view, a side exploded view, a section exploded view, and a rear exploded view of the junction box of FIG. 18A, according to various embodiments.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

An improved weatherproof junction box includes a housing that includes a plurality of sides and a bottom. The plurality of sides and the bottom include a housing material. The housing material fabricated from a non-metallic material. The junction box includes a drill pattern in a side of the plurality of side and/or the bottom. The drill pattern includes a recess indicating a location for creating a hole through the housing. A thickness of the housing material under the drill pattern is sized to meet a fire rating standard applicable to a location where the junction box is installed.

In some embodiments, the drill pattern is a first drill pattern and the recess is a first recess and the junction box includes a second drill pattern positioned on a side of the housing opposite the first drill pattern. The second drill pattern includes a second recess indicating a location for creating a hole through the housing. The second recess is aligned with the first recess and the thickness of the housing material between the first recess and the second recess is sized to meet the fire rating standard applicable to the location where the junction box is installed. In other embodiments, the first drill pattern and/or the second drill pattern include a plurality of recesses indicative of sizes of holes through the housing. Each hole size corresponds to a size of a conduit coupling. The thickness of the housing material between the plurality of recesses of the first and/or the second drill patterns is sized to meet the fire rating standard applicable to the location where the junction box is installed.

In other embodiments, the first drill pattern and/or the second drill pattern include a center recess sized as a drill guide. The drill guide providing a location for a drill bit used to create the hole through the housing. The center recess is centered within the first and/or second recesses. In other embodiments, the side of the plurality of sides and/or the bottom that include the first drill pattern and/or the second drill pattern includes a drill zone marking. The drill zone marking is indicative of locations on the side of the plurality of sides and/or the bottom suitable for penetrating the housing. In other embodiments, the drill zone marking is on the bottom of the housing and the drill zone marking is within a plurality of fastener openings. Each fastener opening of the plurality of fastener openings is configured for a fastener to anchor the junction box to a roof of a structure.

In other embodiments, the housing is configured to mount to a roof of a structure and the bottom of the housing includes an exterior side. The exterior side of the bottom includes a sealant positioned exterior to the drill zone marking. The sealant is configured to prevent liquid from accessing a hole through the housing within an area within the drill zone marking and/or through the roof of the structure. In other embodiments, the housing is configured to mount to a roof of a structure and the housing includes a flashing extending along a plane parallel to an exterior side of the bottom in a direction away from the housing. In other embodiments, the flashing includes a groove positioned between a sealant positioned between an edge of the flashing and the drill zone marking. The groove is sized as a capillary break to prevent liquid entering between the edge of the flashing and the roof by way of capillary action from moving past the groove.

In some embodiments, the side of the plurality of sides and/or the bottom that include the first drill pattern and/or the second drill pattern include a plurality of first drill patterns and/or second drill patterns. In other embodiments, the side of the plurality of sides and/or the bottom that include the plurality of first drill patterns and/or the second drill patterns include a drill zone marking. The drill zone marking is indicative of locations on the side of the plurality of sides and/or the bottom suitable for penetrating the housing.

In some embodiments, the housing is configured to mount to a sloped roof of a structure and the housing includes one or more weep holes through the housing positioned on a downslope side of the housing. The one or more weep holes extend on the downslope side a distance from the bottom of the housing. In other embodiments, the non-metallic material of the housing includes a plastic material, a polycarbonate material, a polyvinyl chloride (“PVC”) material, an acrylonitrile butadiene styrene (ABS) material, acrylonitrile styrene and polycarbonate blend (ASA+PC) material, and/or a polycarbonate and ABS blend (PC+ABS) material.

Another improved weatherproof junction box includes a housing that includes a plurality of sides and a bottom. The plurality of sides and the bottom include a housing material. The housing material is fabricated from a non-metallic material. The junction box includes one or more drill patterns in a side of the plurality of side and/or the bottom. Each of the one or more drill patterns includes a recess indicating a location for creating a hole through the housing. The junction box includes a drill zone marking on a side of the plurality of sides and/or the bottom surrounding the one or more drill patterns. The drill zone marking is indicative of locations on the side of the plurality of sides and/or the bottom suitable for penetrating the housing. A thickness of the housing material under the one or more drill patterns is sized to meet a fire rating standard applicable to a location where the junction box is installed.

In some embodiments, the one or more drill patterns are one or more first drill patterns and the recess of the one or more drill patterns is a first recess and the junction box includes one or more second drill patterns positioned on a side of the housing opposite the one or more first drill patterns. The one or more second drill patterns each include a second recess indicating a location for creating a hole through the housing. Each of the one or more second recesses is aligned with a corresponding first recess. The thickness of the housing material between each of the first recesses and the corresponding second recesses is sized to meet the fire rating standard applicable to the location where the junction box is installed.

In some embodiments, the one or more first drill patterns and/or the one or more second drill patterns include a plurality of recesses indicative of sizes of holes through the housing. Each hole size corresponds to a size of a conduit coupling. The thickness of the housing material between the plurality of recesses of the one or more first drill patterns and/or the one or more second recesses is sized to meet the fire rating standard applicable to the location where the junction box is installed. In other embodiments, the one or more first drill patterns and/or the one or more second drill patterns include a center recess sized as a drill guide. The drill guide provides a location for a drill bit used to create the hole through the housing. The center recess is centered within the first and/or second recesses.

In some embodiments, the drill zone marking is on the bottom of the housing and the drill zone marking is within a plurality of fastener openings. Each fastener opening of the plurality of fastener openings is configured for a fastener to anchor the junction box to a roof of a structure. In other embodiments, the housing is configured to mount to a roof of a structure and the bottom of the housing includes an exterior side. The exterior side of the bottom includes a sealant positioned exterior to the drill zone marking. The sealant is configured to prevent liquid from accessing a hole through the housing within an area within the drill zone marking and/or through the roof of the structure. In other embodiments, the housing includes a flashing extending along a plane parallel to the exterior side of the bottom in a direction away from the housing. In further embodiments, the flashing includes a groove positioned between a sealant positioned between an edge of the flashing and the drill zone marking. The groove is sized as a capillary break to prevent liquid entering between the edge of the flashing and the roof by way of capillary action from moving past the groove. In other embodiments, the housing is configured to mount to a sloped roof of a structure and the housing includes one or more weep holes through the housing positioned on a downslope side of the housing. The one or more weep holes extend on the downslope side a distance from the bottom of the housing.

Another improved weatherproof junction box includes a housing that includes a plurality of sides and a bottom. The plurality of sides and the bottom includes a housing material. The housing material is fabricated from a non-metallic material and the housing is configured to mount to a sloped roof of a structure. The junction box includes one or more first drill patterns in a side of the plurality of side and/or the bottom. Each of the one or more drill patterns includes a first recess indicating a location for creating a hole through the housing. The junction box includes one or more second drill patterns positioned on a side of the housing opposite the one or more first drill patterns. The one or more second drill patterns each include a second recess indicating a location for creating a hole through the housing. Each of the one or more second recesses is aligned with a corresponding first recess. The junction box includes a drill zone marking on a side of the plurality of sides and/or the bottom surrounding the one or more drill patterns. The drill zone marking are indicative of locations on the side of the plurality of sides and/or the bottom suitable for penetrating the housing. The junction box includes flashing extending along a plane parallel to an exterior side of the bottom in a direction away from the housing. A thickness of the housing material between each of the first recesses and the corresponding second recesses is sized to meet a fire rating standard applicable to a location where the junction box is installed.

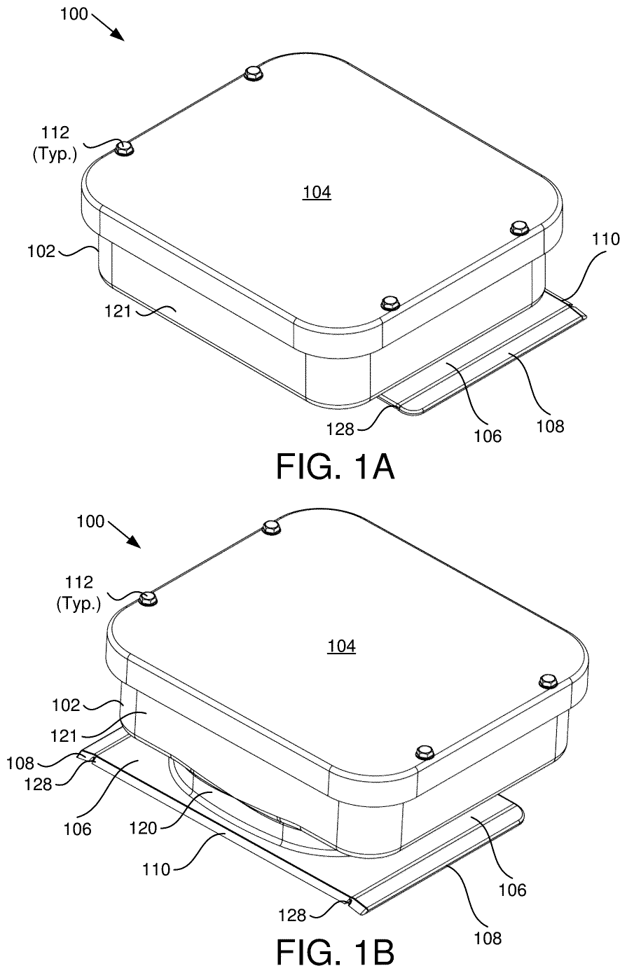

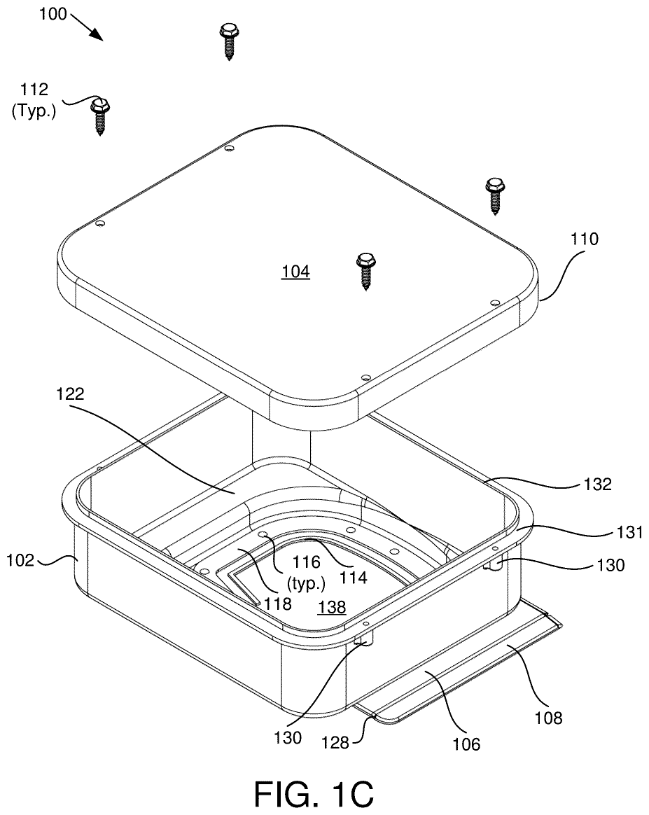

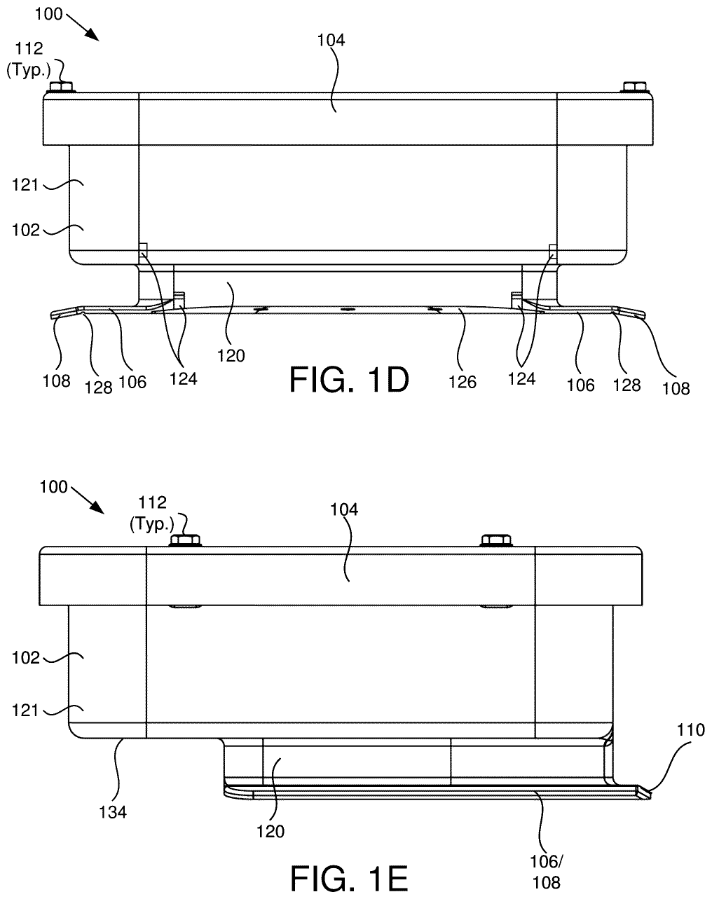

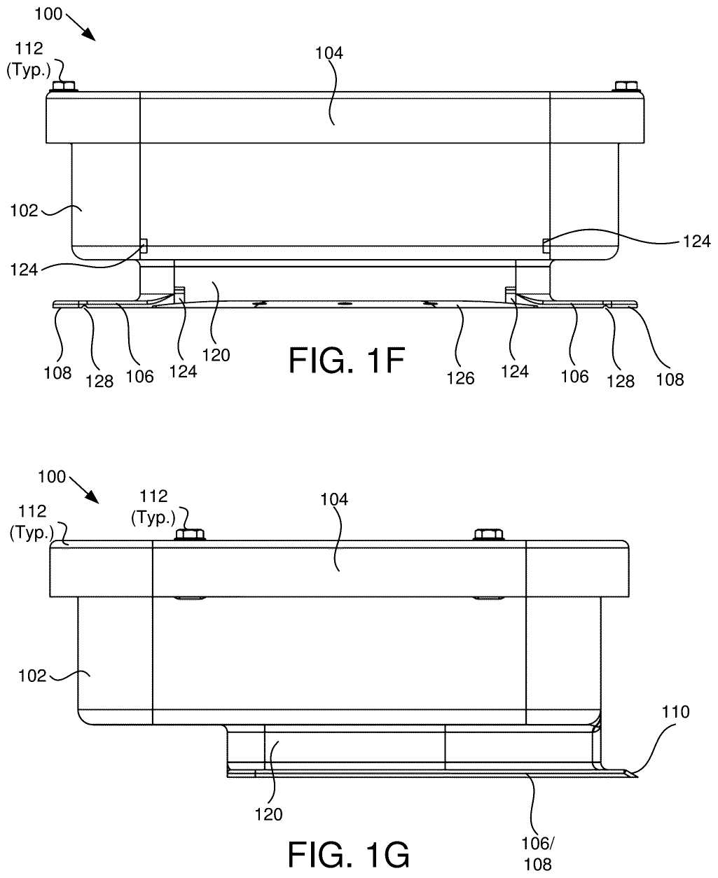

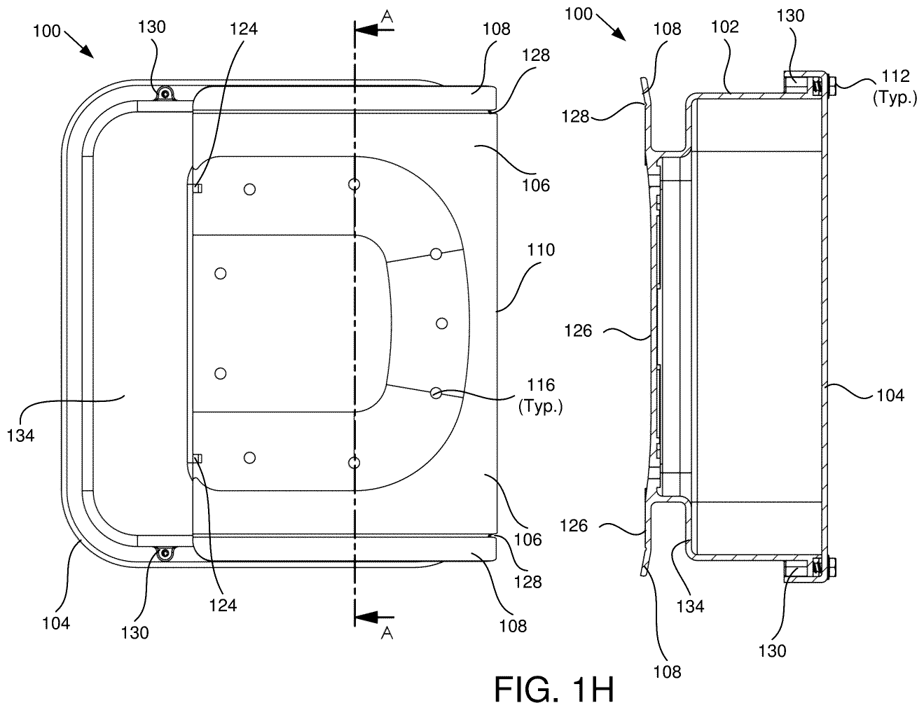

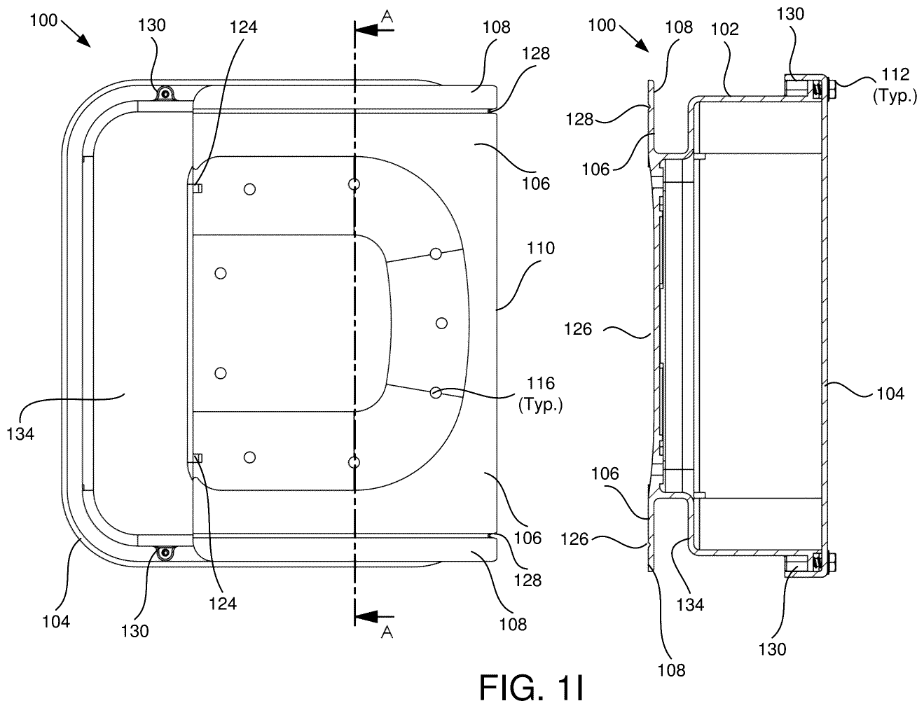

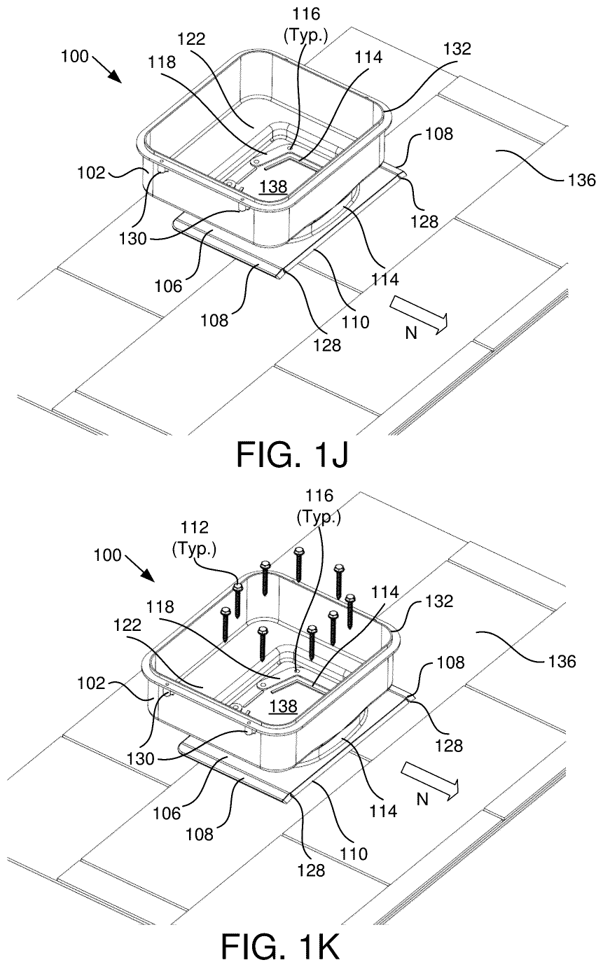

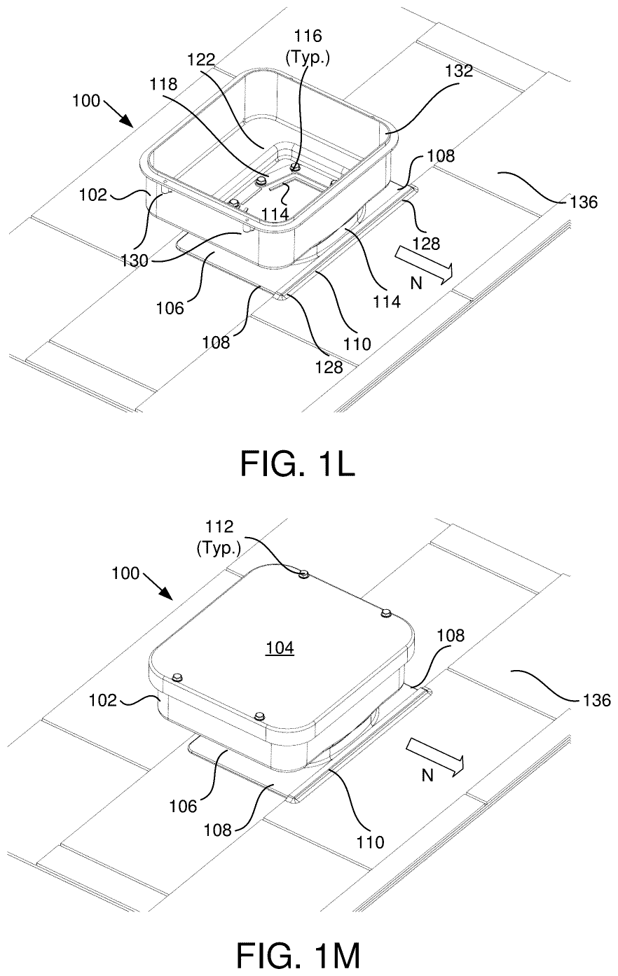

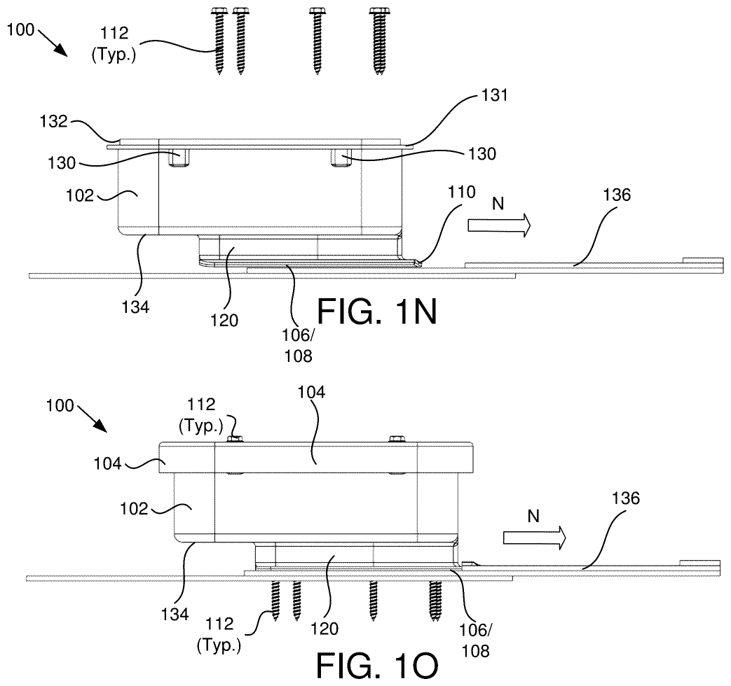

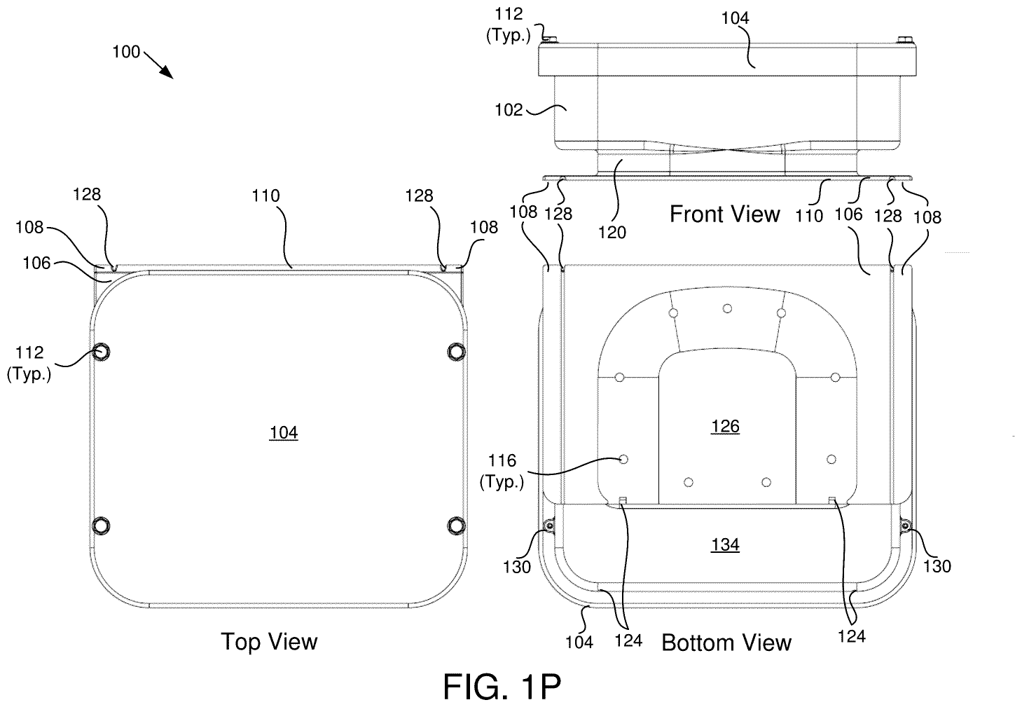

FIG. 1A is a side perspective view illustrating a junction box 100 with flashing 106 with a lid 104 attached, according to various embodiments.

For simplicity, a north, south, east, and west is defined for sides of the junction box 100. As used herein, a north side of the junction box 100 is intended to be a side of the junction box 100 that is mounted on an upper side of a slope of a structure or a top side if mounted vertically. In some examples, the junction box 100 is intended to be mounted on a sloped roof of a structure and a north side is facing towards a peak of the roof. A south side of the junction box 100 is opposite the north side and faces downward or down slope. An east side of the junction box 100 is the right side of the junction box 100 when viewing the junction box 100 with the north side being up. Likewise, a west side of the junction box 100 is a left side of the junction box when viewing the junction box 100 with the north side being up.

FIG. 1A is looking at a south and east side of the junction box 100 where a side flashing 106 is showing. FIG. 1B is another side perspective view illustrating the junction box 100 of FIG. 1A with a housing 102 and a lid 104 attached, according to various embodiments. FIG. 1B depicts the north side of the junction box 100 on the bottom left. The junction box 100 includes lower section 120 that is narrower than an upper section 121 of the housing 102. The north side of the junction box 100 includes a short flashing 106 that has a chiseled edge 110 with a pointed side of the chiseled edge 110 facing down. This north flashing 106 allows the chiseled edge 110 to be slid under a shingle 136 where the length of the north flashing 106 is long enough to reach to about a glue strip of the shingle 136.

The lid 104 is anchored to the housing 102 with fasteners 112, which may be screws, bolts, our other suitable fasteners 112. Sides of the lower section 120 include a flashing 106 with wings 108 that are flexible and angled downward to contact the roof before other portions of the flashing 106 or interior bottom 138 of the housing 102. The capillary break 128 is in the form of a groove on the underside of the flashing 106 that provides a gap large enough so that any liquid, such as water, that is being drawn under the flashing due to capillary action to be stopped. In some embodiments, the capillary breaks 128 have a groove that runs to a south end of the flashing 106 and/or housing 102 and is shaped as a channel to cause liquid to run down the roof to the south end of the junction box 100 instead of continuing to be drawn further under the junction box 100. In some embodiments, the capillary break 128 includes a groove large enough to act as a flex point so that the wings 108 flex upward as the junction box 100 is anchored to the roof.

FIG. 1C is another side perspective view illustrating the junction box 100 of FIG. 1A with the lid 104 removed, according to various embodiments. FIG. 1C is the same as FIG. 1A, but the lid 104 is removed. The narrower lower section 120 is visible within the junction box 100. The interior of the junction box 100 includes a ledge 122 that divides the lower section 120 from the upper section 121, which may be used for mounting devices, such as a ground bar, a terminal block, or the like. In some embodiments, the lower section 120 is configured to fit in place of a shingle 136 without cutting an adjacent shingle 136. The upper section 121 is sized for convenience in working within the housing 102 to terminate wiring, to connect wiring using a wire nut, or the like.

The interior bottom 138 of the housing 102 includes a drill zone marking 114 that denotes a location where drilling would be within sealant (not shown) located on the exterior side of the interior bottom 138 of the housing 102. External to the drill zone marking 114, the housing 102 includes fastener openings 116 configured for a fastener 112 that anchors the housing 102 to a roof.

In some embodiments, a compression ring 118 follows a pattern of the fastener openings 116. In some embodiments, the compression ring 118 is a thickened section of the housing 102 that transfers force from the fasteners 112 along the length of the compression ring 118 to prevent bowing between the fastener openings 116. In other embodiments, the compression ring 118 is a separate element. In other embodiments, the compression ring 118 is made of a stiffer material than the housing 102, such as a metal. The compression ring 118 provides an even force on a sealant under or adjacent to where the compression ring 118 runs to reduce bowing of the bottom of the housing 102 between fastener openings 116 to reduce liquid external to the sealant from leaking into the drill zone denoted by the drill zone marking 114. The compression ring 118 is described more detail in U.S. patent application Ser. No. 18/212,669 filed Jun. 21, 2023 for Ben Wade, et al., which is incorporated herein by reference for all purposes.

The top of the housing 102 is configured to accommodate the lid 104. In some embodiments, the top of the housing 102 includes a boss 130 for each fastener 112 anchoring the lid 104 to the housing 102. In some embodiments, the bosses 130 are external to a wall of the housing 102 so that liquid seeping down around the fasteners 112 would remain external to the housing 102. In some embodiments, the housing 102 includes a lip 132 extending vertically above a ledge 131 where the lid 104 would be mounted so that the lip 132 extends vertically past a lower edge of the lid 104, which further impedes liquid from entering the junction box 100. In some embodiments, the lid 104 includes edges that extend downward over the lip 132 to the ledge 131. In some embodiments, the lid 104 includes a recess that fits over the lip 132. In other embodiments, the recess includes a sealant, such as a rubber gasket or the like that engages a top of the lip 132 to further seal the lid 104 to the housing 102 to form a liquid-tight seal. One of skill in the art will recognize other shapes of the lid 104 and top of the housing 102 that prevent liquid from entering the junction box 100 at a joint between the lid 104 and the housing 102.

FIG. 1D is a rear view of the junction box 100 of FIG. 1A in an unmounted condition, according to various embodiments. FIG. 1D is a view of the south side of the junction box 100 prior to installation. Side flashings 106 are visible to the right and left on the bottom of the housing 102. The side flashings 106 include wings 108 that are angled downward prior to installation. The side flashings 106 each include a groove near the edges that is a capillary break 128. Water or other liquid on the roof of the structure near the side flashing 106 will creep under the side flashing 106 due to capillary action, but the capillary action will tend to stop at the capillary break 128. In some embodiments, the bottom of the housing 102 includes a concave bottom exterior 126 shaped to maintain a gap between the roof and the housing 102. The concave bottom exterior 126 provides another mechanism to prevent liquid from entering the junction box 100 in addition to the flashing 106, the wings 108 of the flashing 106, the capillary breaks 128, sealant, etc.

In some embodiments, the housing 102 includes one or more weep holes 124. In some embodiments, the weep holes 124 are located on the south end of the housing 102. Where the roof is sloped and the junction box 100 mounted to the roof with a north end facing upslope, weep holes 124 on the south end of the housing 102 provide a mechanism to allow liquid to drain from an interior of the housing 102. In some embodiments, the lower section 120 includes at least one weep hole 124. In other embodiments, the lower section 120 includes two or more weep holes 124 so that if a weep hole 124 blocked, another weep hole 124 may allow liquid to drain from the lower section 120. In other embodiments, the upper section 121 includes one or more weep holes 124. In some embodiments, the upper section 121 includes one or more weep holes 124 located at an end of the ledge on the south side of the upper section 121. In some embodiments, the upper section 121 includes two or more weep holes 124.

In some embodiments the weep holes 124 extend from the bottom of the housing 102 up a side wall a distance. Having the weep holes 124 extend up a side wall is useful in avoiding having debris, ice, etc. completely block the weep holes 124. In some embodiments, the weep holes 124 are sized to allow liquid to drain and to prevent surface tension of the liquid from stopping liquid from exiting the junction box 100. In other embodiments, the weep holes 124 are sized to be smaller than common insects, such as bees, wasps, etc. and possibly smaller than ants, earwigs, etc.

FIG. 1E is a side view of the junction box 100 of FIG. 1A in an unmounted condition, according to various embodiments. FIG. 1E is an east side of the junction box 100. The upper section 121 includes an overhang 134 where the lower section 120 has a footprint smaller than the upper section 121. In some embodiments, a length of the lower section 120 from the north end (right side) to the south end (left side) of the lower section 120 is sized to cover a single course of shingles 136. Shingles 136 often are available in standard sizes with a prescribed amount of overlap that leaves a common distance between shingles 136 in a direction from north to south. Beneficially, sizing the lower section 120 to match the distance between shingles 136 allows an installer to cut a single shingle 136 to accommodate the junction box 100 rather than having to cut multiple shingles 136 in a north-south direction. In addition, the overhang 134 covers the south edge of the lower section 120, which further helps to prevent liquid from entering between the bottom of the junction box 100 and the roof along the south edge of the lower section 120.

FIG. 1F is a rear (south) view of the junction box 100 of FIG. 1A in a mounted condition, according to various embodiments. FIG. 1G is a side (east) view of the junction box 100 of FIG. 1A in the mounted condition, according to various embodiments. The side flashings 106 are compressed flat as the junction box 100 is secured to the structure using fasteners 112 in the fastener openings 116 at the bottom of the lower section 120. In some embodiments, the concave bottom exterior 126 remains above the roof after mounting, which further prevents liquid from entering the drill zone area under the drill zone marking 114 by way of capillary action. The gap formed between the concave bottom exterior 126 and the roof also promotes liquid from running down the roof away from under the junction box 100.

FIG. 1H is a bottom view and a section view of the junction box 100 of FIG. 1A in an unmounted condition, according to various embodiments. Lines in a center portion of the concave bottom exterior 126 indicate a concave shape intended to keep a central area or drill zone of the junction box 100 off of the structure after mounting, which again would reduce capillary action. Fastener openings 116 are depicted for securing the junction box 100 to the structure. The fastener openings 116, in some embodiments, correspond to a sealant and compress the sealant to form a continuous C-shaped portion to the north, east, and west sides of the bottom to protect the central area to keep out liquid. The side flashings 106 are depicted in an uncompressed state.

FIG. 1I is a bottom view and a section view of the junction box 100 of FIG. 1A in a mounted condition, according to various embodiments. FIG. 1I is the same as FIG. 1H, except that the junction box 100 is in a mounted condition where the wings 108 of the side flashings 106 are flat. Note the capillary break 128 lines just inside edges of the side flashings 106. The north side of the bottom view faces right.

From the section view, the lid 104 is secured to the junction box 100 via fasteners 112. The fasteners 112 are positioned outside a lip 132 that extends to the lid 104 so that any liquid entering around the fasteners 112 drains to a bottom of a boss 130 for the fasteners 112 and out a hole in the bottom of the boss 130, in some embodiments.

FIG. 1J is a perspective view of the junction box 100 of FIG. 1A prior to mounting on a roof with shingles, according to various embodiments. North is depicted by an arrow and an “N.” FIG. 1K is a perspective view of the junction box 100 of FIG. 1A prior to mounting on a roof with shingles 136 where the fasteners 112 are screws, according to various embodiments. The screws are positioned vertical with respect to corresponding fastener openings 116 for the screws. FIG. 1L is a perspective view of the junction box 100 of FIG. 1A in a mounted condition on a roof with shingles 136 where the lid 104 is removed, according to various embodiments. The north flashing 106 with the chiseled edge 110 is depicted under a shingle 136 and, in some embodiments, extends to a point just before a glue strip of the shingle 136. In some embodiments, the chiseled edge 110 is shaped to allow an installer to use the chiseled edge 110 to pry up the shingle 136 enough to slide the north flashing 106 under the shingle 136. In some examples, the chiseled edge 110 is angled to facilitate prying up the shingle 136. FIG. 1M is a perspective view of the junction box 100 of FIG. 1A in a mounted condition on a roof with shingles where the lid 104 attached, according to various embodiments. FIG. 1M is the same as FIG. 1L, except with the lid 104.

FIG. 1N is a side view of the junction box 100 of FIG. 1A in an unmounted condition on a roof with shingles 136, according to various embodiments. FIG. 1N is a side view that is similar to the junction box 100 in FIG. 1K. FIG. 1O is a side view of the junction box 100 of FIG. 1A in a mounted condition on a roof with shingles, according to various embodiments. FIG. 1O is a side view that is similar to the junction box 100 in FIG. 1M and shows the north flashing 106 extending under a shingle 136.

FIG. 1P is a top view, a bottom view, and a front view of the junction box 100 of FIG. 1A, according to various embodiments. The bottom view is similar to the bottom view of FIG. 1H.

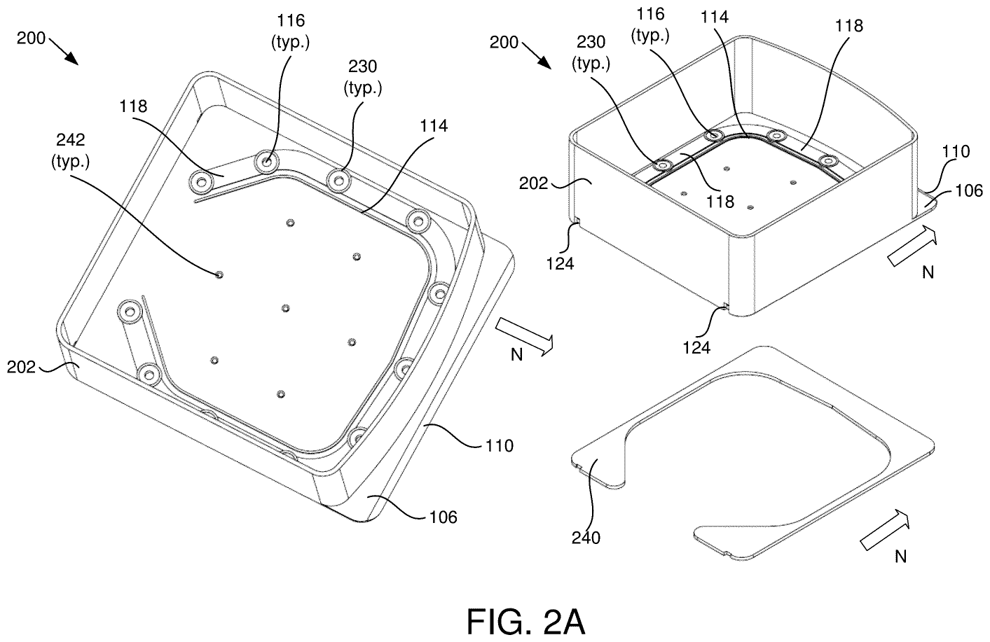

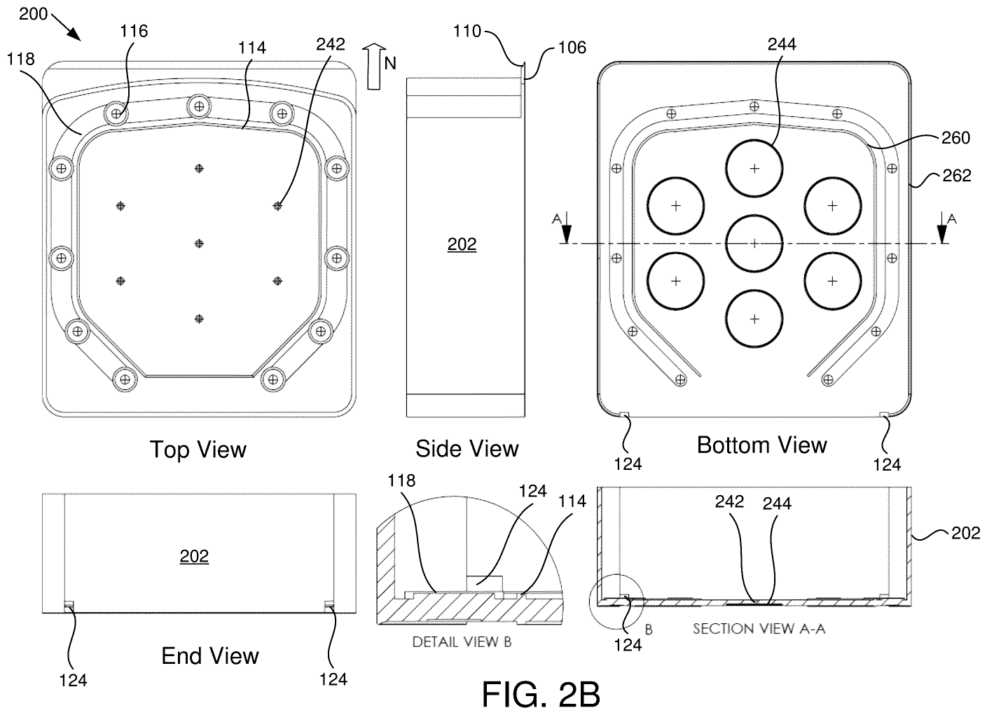

FIG. 2A includes two perspective views illustrating a junction box 200 without flashing without a lid 104, and a sealant 240 configured to be mounted between a bottom of the junction box 200 and a structure, according to various embodiments. FIG. 2B is a top view, a side view, a bottom view, a rear view, a section view, and a detailed section view of the junction box 200 of FIG. 2A, according to various embodiments.

The junction box 200 of FIGS. 2A and 2B does not include side flashings. FIG. 2A depicts a sealant 240 on the bottom right. The sealant 240 is configured to fit between an inner ridge 260 and an outer ridge 262 on the bottom of the junction box 200. The inner ridge 260 is on a side of where fastener openings 116 (e.g., holes for screws in some embodiments) towards the center of the junction box 200. The outer ridge 262 is near an outer edge of the junction box 200. In some embodiments, edges of the sealant 240 follow the inner and outer ridges 260, 262 so that the sealant 240 is substantially under areas of the junction box 200 outside a central area of the junction box 200 surrounded by a drill zone marking 114. A south side of the junction box 200, in some embodiments, is free from the sealant 240 so any liquid under the central area of the junction box 200 will drain out along a south side of the junction box 200. In other embodiments, the junction box 200 includes some sealant 240 along a south side of the central area but includes one or more gaps for liquid to drain.

The top view on FIG. 2B depicts a compression ring 118 that follows a line of fastener openings 116 for fasteners 112 (e.g., screws or similar fasteners) and aids in compressing the sealant 240 in areas between the fastener openings 116 by preventing unwanted bulging between fastener openings 116 that may prevent a full seal around the central area. In some embodiments, each fastener opening 116 includes a boss 230 configured to position a fastener 112 in the fastener opening 116. In some embodiments, each boss 230 extends a distance above the bottom of the housing 202 to provide additional support for anchoring the housing 202 to a structure. In other embodiments, each boss 230 is configured so that a top of the fastener 112 is recessed in the boss 230 when the fastener 112 is fully installed.

A line (e.g., drill zone marking 114) just inside the compression ring indicates a drill zone where drilling will not impact the sealant 240 and inner ridge 260. Other embodiments may include a drill zone marking 114 with a coloring, a hatch pattern, or other marking on the bottom of the junction box 200 to indicate the drill zone. Small circles in the drill zone are drill pattern center points 242 indicate places to start drilling a hole and, in some embodiments, are depressions. The bottom view includes larger circles, which are drill patterns 244 within the drill zone, which correspond to an outer limit of holes that may be drilled in the bottom of the junction box 200 and, in some embodiments, are sized for a particular conduit connector.

The bottom view depicts an inner ridge 260 between the central area of the drill zone and an indication of the compression ring 118. The compression ring 118, typically, is on the bottom interior 138 of the junction box 200 facing upward into the interior of the junction box 200, as shown in the top view of FIG. 2B and the compression ring 118 on the bottom view is indicated merely as a reference. An outer ridge 262 is depicted on the bottom view along an edge of the junction box 200 on the north, east, and west sides. The south side of the bottom of the junction box 200, in some embodiments, includes at least a portion without an outer ridge 262 to allow liquid under the junction box 200 to run out from under the junction box 200.

The end view is from the south side of the junction box 200 and includes two weep holes 124 that allow liquid in the junction to drain out. The weep holes 124 extend a distance up the side walls. In other embodiments, the weep holes 124 are placed elsewhere.

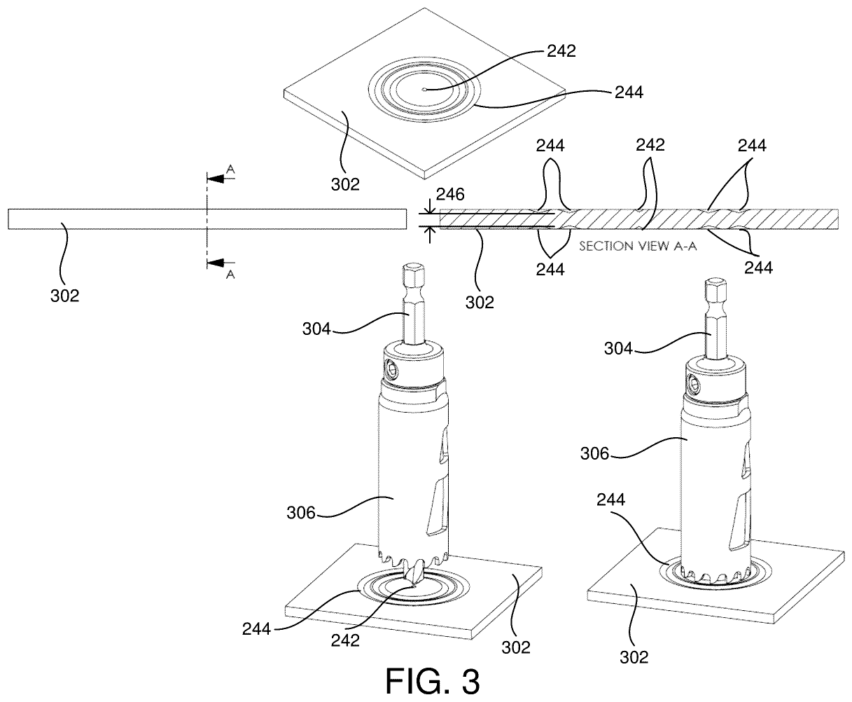

FIG. 3 is a perspective view of a portion 302 of a bottom or a side of a junction box (e.g., 100, 200 or other junction boxes 800, 900, 1300, 1400, 1600, 1700, 1800 described below) described herein with a drill pattern, a side view of the bottom or side, a section view of the bottom or side, a hole saw bit of a drill prior to drilling and during drilling where the hole saw bit is aligned with the drill pattern, according to various embodiments.

The perspective view of the portion 302 of the bottom or side at the top of FIG. 3 depicts several concentric circles, which are drill patterns 244. In some embodiments, such as where the junction box 100, 200 is non-metallic, the bottom and sides of the junction box have a thickness to meet fire ratings. In some instances, the thickness of the junction box 100, 200, 800, 900, 1300, 1400, 1600, 1700, 1800 is more than a thickness allowable for conduit connectors to snap into an opening in the bottom or side of the junction box 100, 200, 800, 900, 1300, 1400, 1600, 1700, 1800. The concentric rings of the drill pattern 244 allow for a decreased thickness associated with several known conduit connector sizes. The section view depicts indentations corresponding to known conduit connector sizes.

On the bottom left, a hole saw bit 304 with a hole saw attachment 306 is depicted just above the concentric rings of the drill pattern 244 at a drill pattern center point 242. The drill pattern center point 242 helps to keep the hole saw drill bit 304 centered. On the bottom left, a drill bit portion of the hole saw drill bit 304 has created a hole and the hole saw attachment 306 is about to cut a hole that is sized to correspond to a desired conduit connector. Once the hole saw bit 304 cuts a hole, edges of the newly formed hole will include sloped edges corresponding to the indentations of the concentric rings of the drill patterns 244 where an edge of the hole is thinner than the surrounding material of the junction box 100, 200, 800, 900, 1300, 1400, 1600, 1700, 1800.

In some embodiments, the indentations or recesses for the concentric rings of the drill patterns 244 are sized to allow a conduit connector to snap into the hole due to the tapered edges of the hole creating a portion that is thinner than other portions of the junction box. In some embodiments, the thinner edges around the holes is sized to meet a fire rating standard applicable to a location where the junction box 100, 200, 800, 900, 1300, 1400, 1600, 1700, 1800 is installed. In some embodiments, the junction box 100, 200, 800, 900, 1300, 1400, 1600, 1700, 1800 is subject to fire ratings of the 2022 edition of the National Electrical Code (“NEC”) Sections 300.21, 300.22, 760.3(A), 770.26, 800.26, 840.26, or the like or similar standards from a more recent version of the NEC are applicable standards.

In other embodiments, the junction box 100, 200, 800, 900, 1300, 1400, 1600, 1700, 1800 is subject to fire ratings of Underwriters Laboratories (“UL”) Section 263, or the like. Other applicable standards include the 2018 edition of the National Fire Protection Agency (“NFPA”) 101 Section 8.3.4.2 or similar standards from a more recent version of the NFPA 101. Other applicable standards include the 2018 edition of the International Building Code (“IBC”) Sections 508.4, 706.9, 714.2, 721, 722 or similar standards from a more recent version of the IBC. Other standards include American Society for Testing and Materials (“ASTM”) E119 or the like. The standards listed above are included as examples and are not all-inclusive. One of skill in the art will recognize other applicable fire rating standards based on a location where the junction box 100, 200, 800, 900, 1300, 1400, 1600, 1700, 1800 is installed.

In the embodiments depicted in FIG. 3, recesses for a drill pattern 244 are located on either side of the portion 302 of the bottom or side of the junction box 100, 200, 800, 900, 1300, 1400, 1600, 1700, 1800 with a thickness 246 of material between the recesses of the drill patterns 244 where this thickness 246 is sufficient to meet applicable fire rating standards. In some embodiments, the bottom or side may include recesses of a drill pattern 244 on one side without a drill pattern 244 on the other side where this thickness 246 is sufficient to meet applicable fire rating standards.

In some embodiments, the side or bottom includes a drill zone marking 114 that includes multiple drill patterns 244 within a drill zone marked by the drill zone marking 114. In other embodiments, the drill zone includes only one or more drill pattern center points 242 without includes circular recesses of a full drill pattern 244.

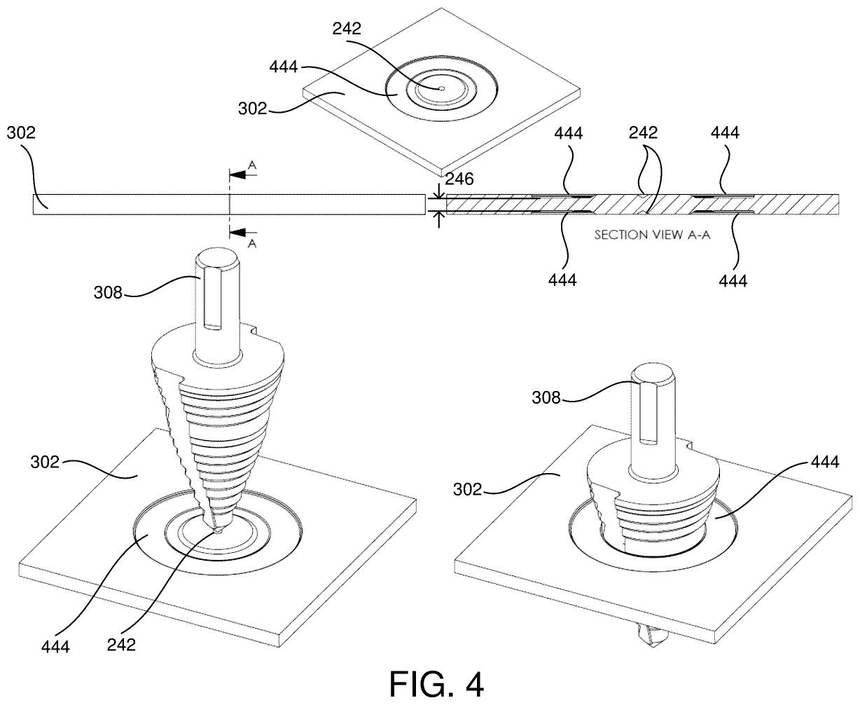

FIG. 4 is a perspective view of a portion 302 of a bottom or a side of a junction box (e.g., 100, 200, 800, 900, 1300, 1400, 1600, 1700, 1800) described herein with an alternate drill pattern 444, a side view of the bottom, a section view of the bottom, a step drill bit 308 of a drill prior to drilling and during drilling where the step drill bit 308 is aligned with the alternate drill pattern 444, according to various embodiments.

The embodiments includes the alternate drill pattern 444 depicted to include an indentation or recess that is wider than the individual concentric rings of the drill pattern 244 of FIG. 3. This wider portion allows for a step drill bit 308 to cut a desired hole size while allowing an area surrounding the newly formed hole to be thin enough for a standard conduit connector to snap into place. In some embodiments, the thinned area is small enough for the junction box 100, 200, 800, 900, 1300, 1400, 1600, 1700, 1800 to meet applicable fire ratings.

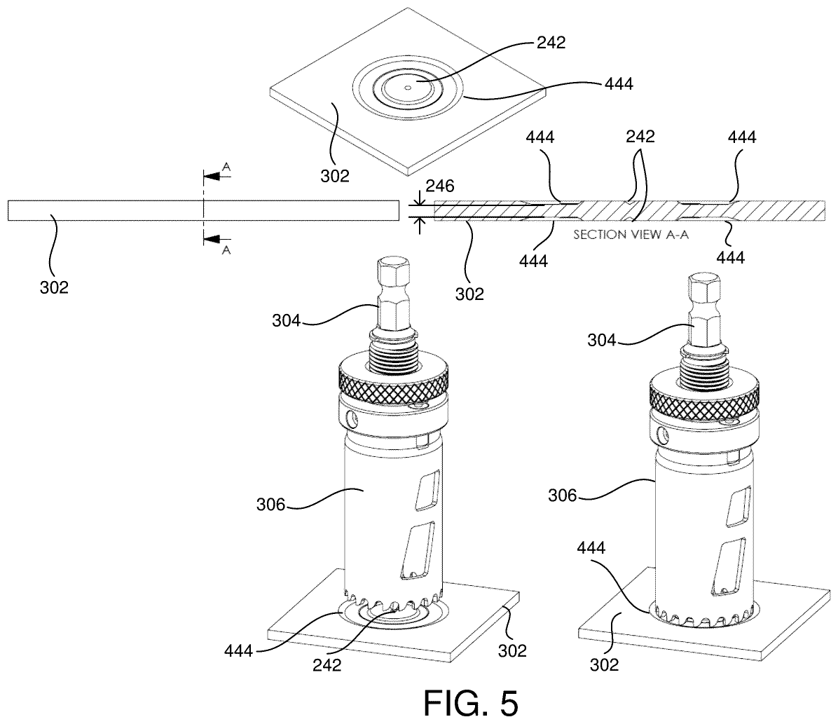

FIG. 5 is a perspective view of a portion 302 of a bottom or a side of a junction box (e.g., 100, 200, 800, 900, 1300, 1400, 1600, 1700, 1800) described herein with the alternate drill pattern 444 of FIG. 4, a side view of the bottom, a section view of the bottom, a hole saw bit 304 of a drill prior to drilling and during drilling where the hole saw bit 304 is aligned with the alternate drill pattern 444, according to various embodiments. The embodiments of FIG. 5 using a hole saw bit 304 are essentially the same as in FIG. 4.

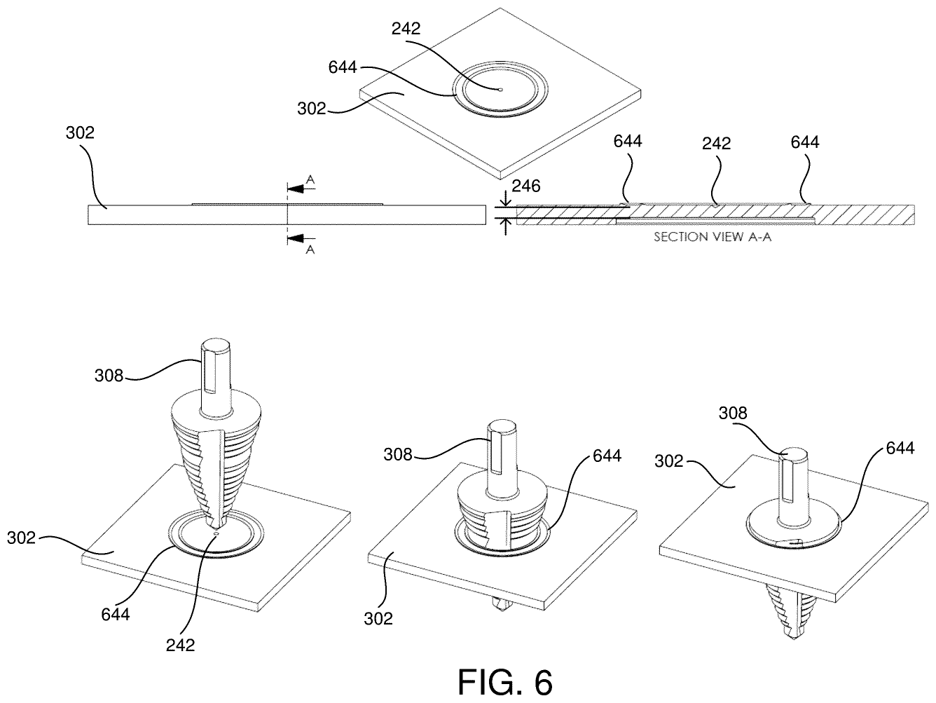

FIG. 6 is a perspective view of a portion of a bottom or a side of a junction box (e.g., 100, 200, 800, 900, 1300, 1400, 1600, 1700, 1800) described herein with an third drill pattern 644 with a thinned section, a side view of the bottom, a section view of the bottom, a step drill bit 308 of a drill prior to drilling and during drilling where the step drill bit 308 is aligned with the third drill pattern 644, according to various embodiments. In the embodiments, the third drill pattern 644 includes a uniform thinned section on the bottom while a top includes concentric rings indicative of standard conduit connector sizes. While a step drill bit 308 is shown, a hole saw bit 304 will also function to cut a desired hole. The thinned bottom section is configured so that once a hole is cut a conduit connector is able to snap into the hole due to the thinned section. In some embodiments, the thinned section is small enough to not impact the fire rating of the junction box 100, 200, 800, 900, 1300, 1400, 1600, 1700, 1800.

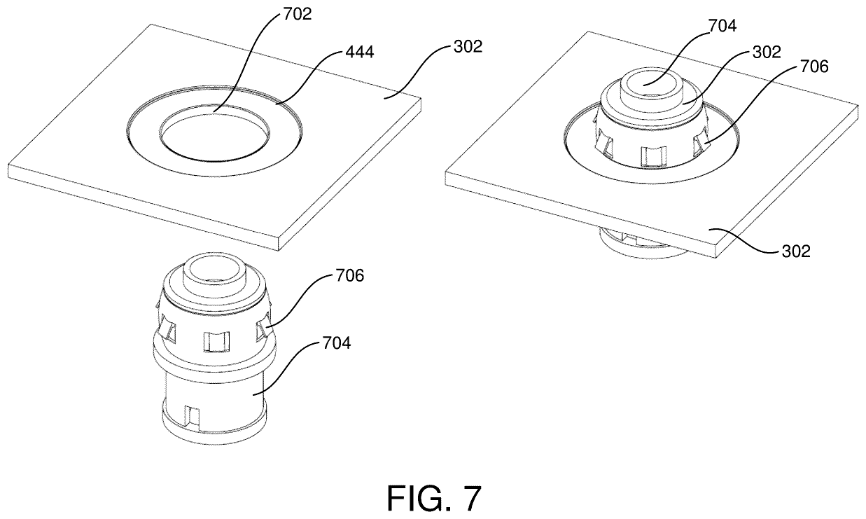

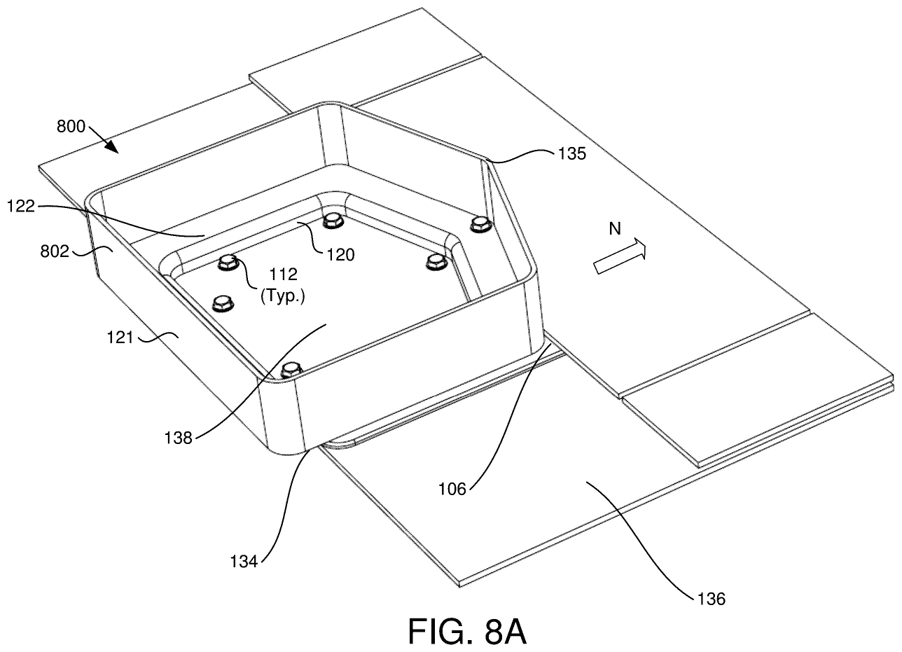

FIG. 7 is a perspective view of a portion 302 of a bottom or a side of a junction box (e.g., 100, 200, 800, 900, 1300, 1400, 1600, 1700, 1800) described herein with a hole 702 drilled therein and a conduit connector 704 just prior to and after connection of the conduit connector 704 in the hole 702, according to various embodiments. The embodiments of FIG. 7 include a hole 702 drilled through a drill pattern, such as the alternate drill pattern 444 of FIG. 4. Other drill patterns 244, 644 may also be used. The conduit connector 704 is shown on the left prior to insertion into the hole 702. After the conduit connector 704 is inserted, tabs 706 on the sides of the conduit connectors 704 pop out and engage edges of the hole 702. If the material where the conduit connector 704 is too thick, the tabs 706 do not extend and the conduit connector 704 does not pop out and the conduit connector 704 is not locked into the hole 702. Thus, the thinner section of a drill pattern 244, 444, 644 provide a way for the conduit connector 704 to lock into a hole 702 in the junction box 100, 200, 800, 900, 1300, 1400, 1600, 1700, 1800.

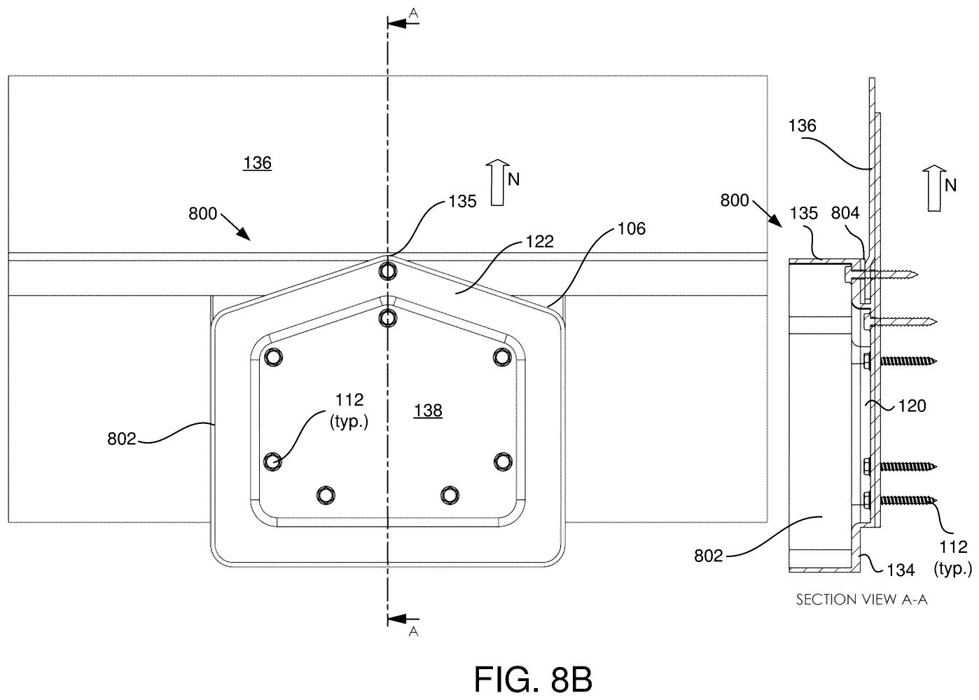

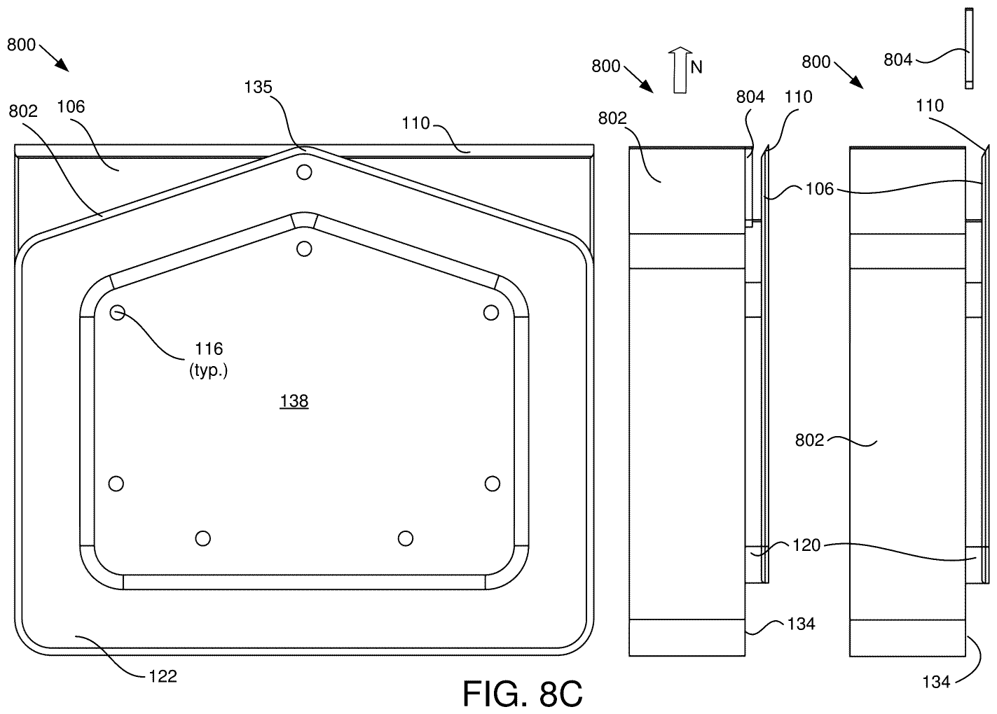

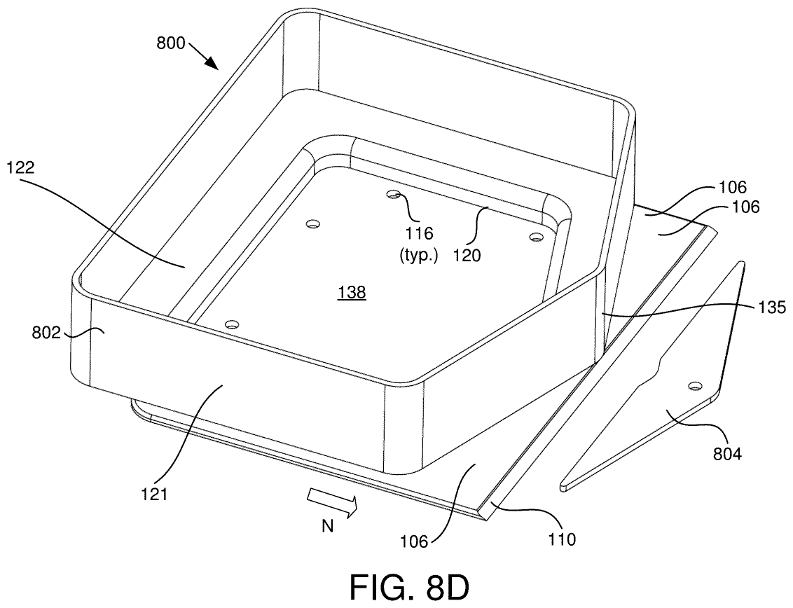

FIG. 8A is a perspective view of a housing 802 of a junction box 800 with flashing 106 without a lid 104 attached with the junction box 800 mounted to a shingled roof 136, according to various embodiments. The junction box 800 includes a smaller lower section 120 and a larger upper section 121. A north portion is angled to a north point 135 to deflect liquid to the around to the sides of the junction box 800. A north side of the junction box 800 overhangs a shingle 136 and includes a separate fastener 112 at the upper-most part of the junction box 800 that would go through the shingle 136 overhanging the north flashing 106. Other fasteners 112 are in the interior bottom 138 of the lower section 120. In some embodiments, the fasteners 112 in the lower section 120 align with a sealant (not shown) to compress the sealant to form a seal running in line with the west, north, and east sides around a center drill zone. A compression ring 118 is not depicted, but may be included. A south side of the center section or drill zone, in some embodiments, does not include sealant.

FIG. 8B is a top view while mounted and a side section view while mounted of the junction box 800 of FIG. 8A, according to various embodiments. FIG. 8C is a top view, a side view with an upper sealant 804 installed, and a side view with the upper sealant 804 removed of the junction box 800 of FIG. 8A, according to various embodiments. The section view in FIG. 8B depicts the north edge of the upper section 121 of the housing 802 overhanging a shingle 136 where the shingle 136 overlaps a north flashing 106 of the junction box 800. In some embodiments, the north flashing 106 includes a chiseled edge 110 that extends under the shingle 136 to a glue strip or similar sealing means of the shingle 136. The right side view in FIG. 8C depicts an upper sealant 804 that is inserted over the shingle 136 once the north flashing is inserted under the shingle 136. The left side view in FIG. 8C adjacent to the top view on the left side depicts the upper sealant 804 in place. The fastener 112 depicted in FIGS. 8A and 8B in the northern corner of the upper section 121 is configured to extend through the upper sealant 804.

FIG. 8D is a top perspective view of the housing 802 of the junction box 800 of FIG. 8A with the upper sealant 804 removed, according to various embodiments. The upper sealant 804 is angled to conform to angled shape of the northern edge of the upper section 121 of the housing 802. The chiseled edge of the north flashing is apparent in FIG. 8D.

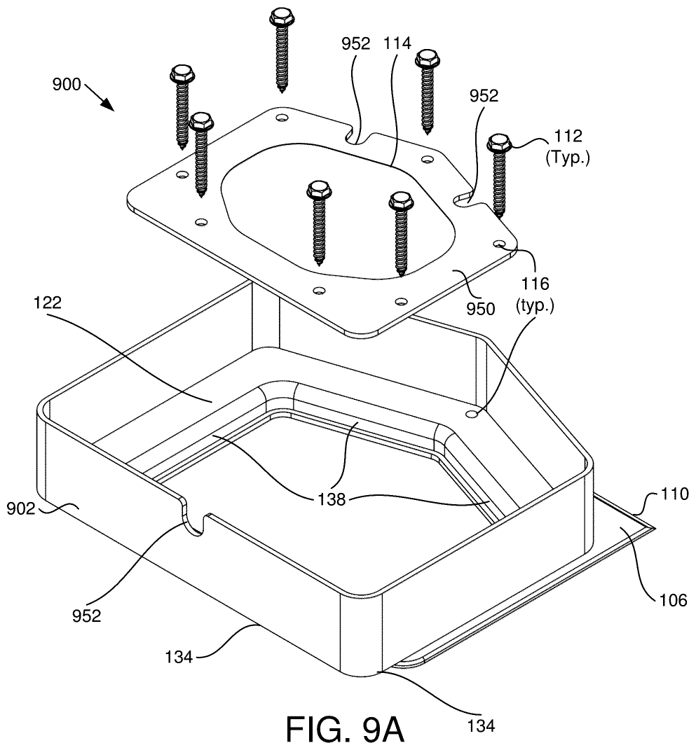

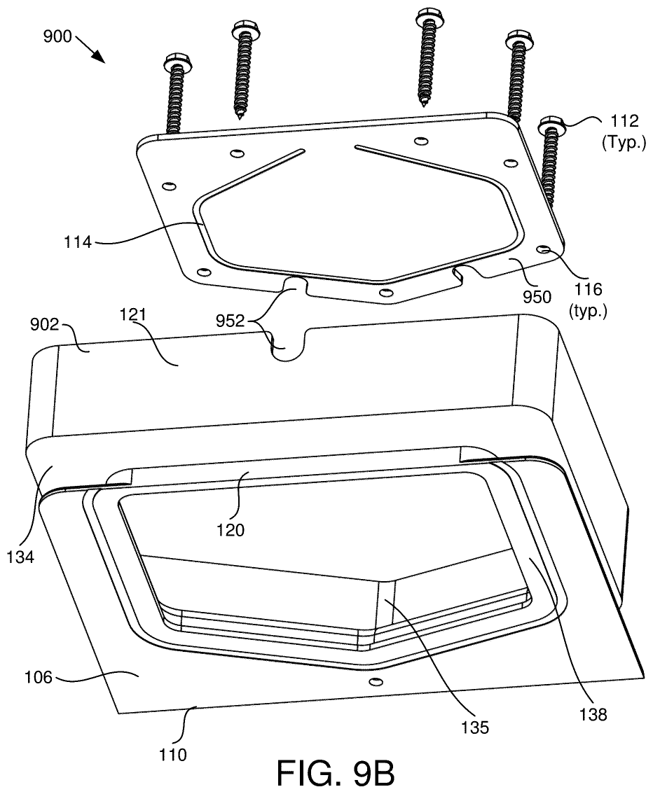

FIG. 9A is a perspective view of a housing 902 of a junction box 900 with a removable bottom plate 950 and fasteners 112 to be inserted from a top of the junction box 900 where the housing 902 of the junction box 900 has a flashing 106, according to various embodiments. FIG. 9B is a bottom perspective view of the housing 902 of the junction box 900 of FIG. 9A, according to various embodiments. The housing 902 includes an opening in the bottom and the removable bottom plate 950 is sized larger than the opening in the bottom 138 so that the plate rests against edges around the opening in the bottom 138. In some embodiments, edges around the opening of the bottom 138 include a step sized to accommodate the removable bottom plate 950 to keep the removable bottom plate 950 in alignment with the housing 902 of the junction box 900. In some embodiments, the removable bottom plate 950 is metallic or of a material that differs from the housing 902 of the junction box 900.

In other embodiments, the housing 902 of the junction box 900 and removable bottom plate 950 include notches 952 as depicted for low voltage wiring. The notch 952 at the top south side of the housing 902, in some embodiments, is sized to fit under a lip of a lid 104 to minimize any entry of liquid through the notch 952. In some embodiments, the removable bottom plate 950 includes a drill zone marking 114, as depicted. In some embodiments, the removable bottom plate 950 is thinner than a thickness of sides and the bottom of the housing 902 and the thickness of the removable bottom plate 950 accommodates conduit connectors 704 snapping into holes 702 in the removable bottom plate 950.

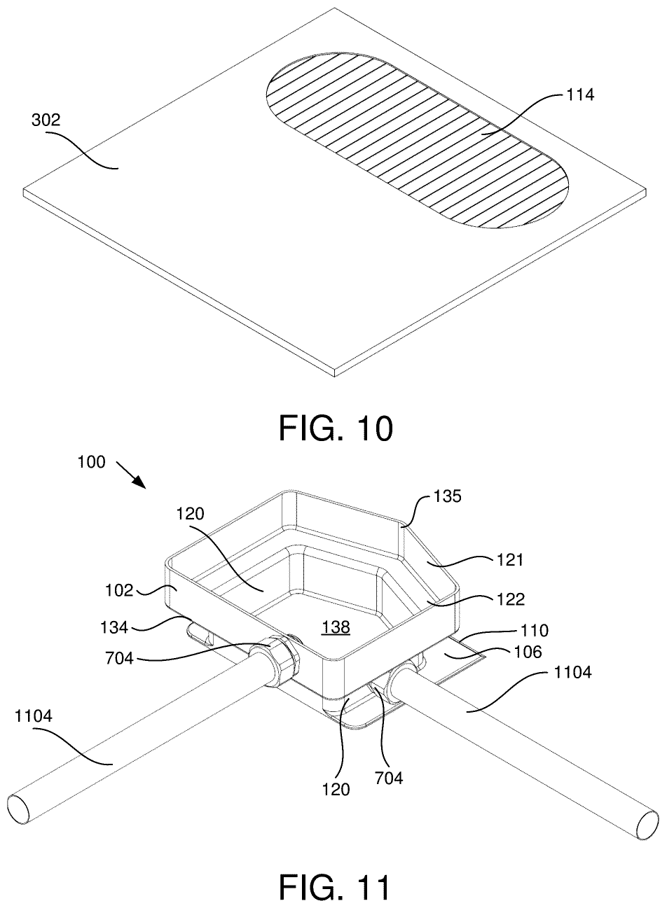

FIG. 10 is a bottom perspective view of a portion 302 bottom of a junction box 100, 200, 800, 900, 1300, 1400, 1600, 1700, 1800 described herein with a drill zone marking 114, according to various embodiments. The portion 302 of the bottom includes an oval-shaped pattern that is a drill zone marking 114 where drilling from the bottom would be allowable. In some embodiments, the junction box 100, 200, 800, 900, 1300, 1400, 1600, 1700, 1800 may be moved around so that the bottom drill zone marking 114 is visible through a hole in a roof of a structure and then the junction box 100, 200, 800, 900, 1300, 1400, 1600, 1700, 1800 is anchored. Drilling through the hole in the roof will then result in a hole in the junction box 100, 200, 800, 900, 1300, 1400, 1600, 1700, 1800 that is properly placed to avoid damage to components of the junction box 100, 200, 800, 900, 1300, 1400, 1600, 1700, 1800.

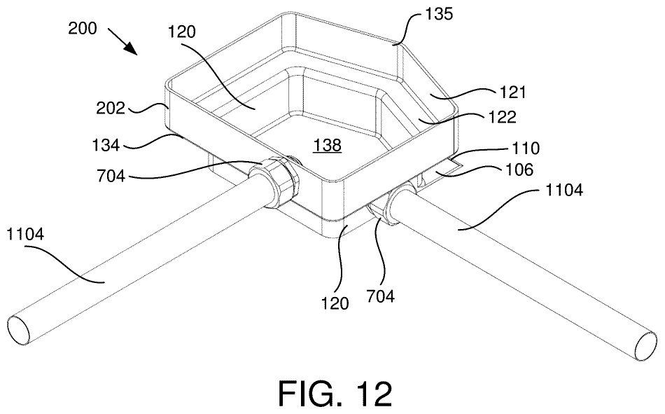

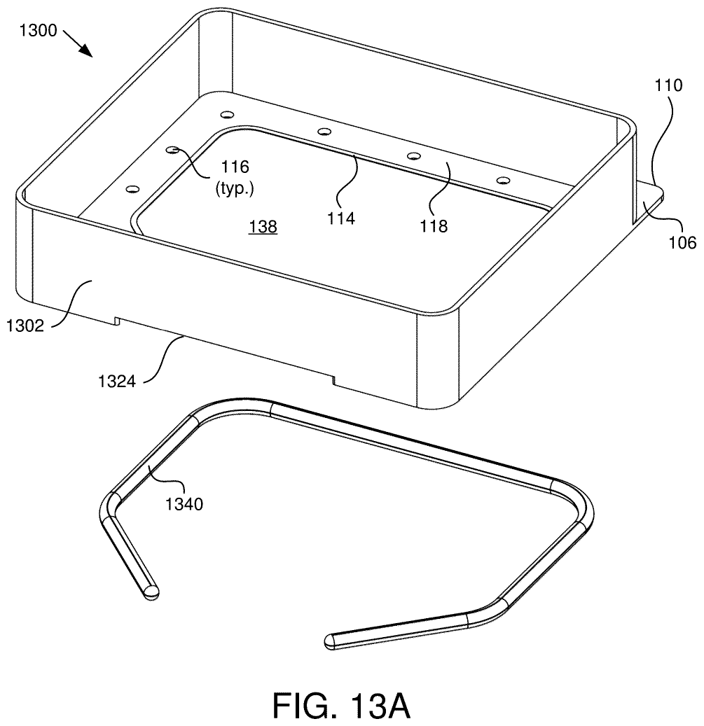

FIG. 11 is a perspective view of the housing 102 of the junction box 100 of FIG. 1A with conduit 1104 and conduit connectors 704 installed at an upper section 121 and at a lower section 120 of the junction box 100, according to various embodiments. FIG. 12 is a perspective view of the housing 202 the junction box 200 of FIG. 2A with conduit 1104 and conduit connectors 704 installed at an upper section 121 and at a lower section 120 of the junction box 200, according to various embodiments. Conduit 1104 entering the lower section 120 of one of the housings 102, 202 of the junction boxes 100, 200 is somewhat shielded from rain, snow, etc. falling on the junction boxes 100, 200.

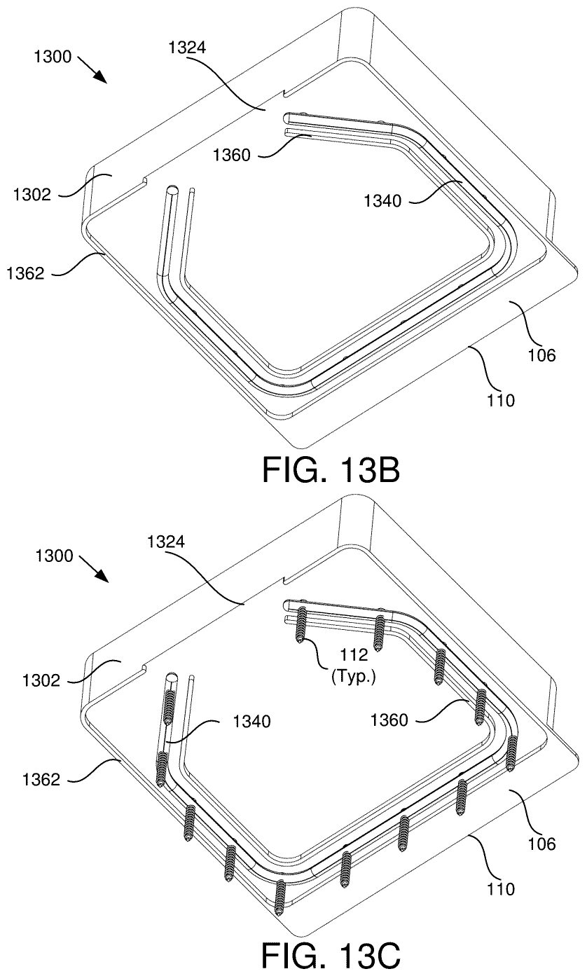

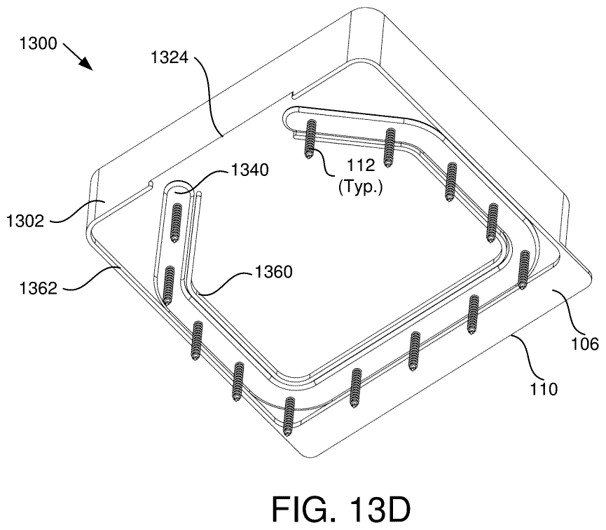

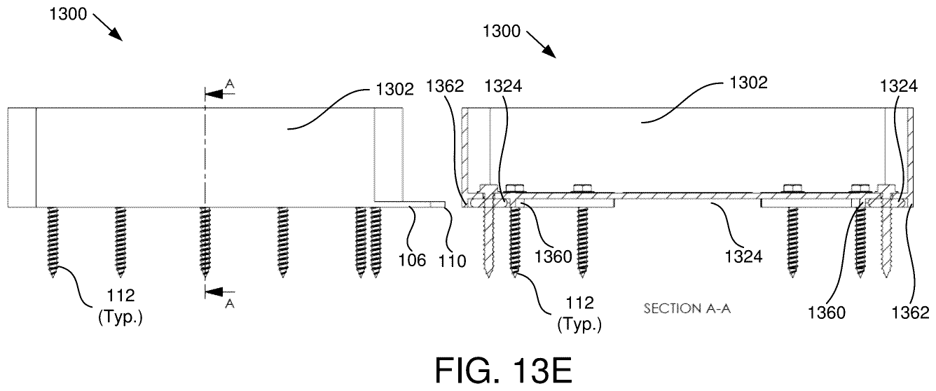

FIG. 13A is a top perspective view of a housing 1302 of a junction box 1300 without side flashing and a perspective view of a sealant 1340 to be mounted to the bottom of the junction box 1300, according to various embodiments. In some embodiments, the junction box 1300 includes a compression ring 118, as depicted. In other embodiments, the lines inside the junction box 1300 indicate a drill zone marking 114. Other embodiments include both a compression ring 118 and line for a drill zone. The sealant 1340 is shaped to align with fastener openings 116 in the bottom 138 of the junction box 1300. In some embodiments, the sealant 1340 covers the west, north and east sides of the junction box 1300 and extends towards a south edge of the junction box 1300 but has a weep hole 1324, which is an opening for liquid to exit an area under the junction box 1300.

FIG. 13B is a bottom perspective view of the housing 1302 of the junction box 1300 of FIG. 13A with the sealant 1340 installed, according to various embodiments. FIG. 13C is a bottom perspective view of the junction box 1300 of FIG. 13A with the sealant 1340 and fasteners 116 in the form of screws installed, according to various embodiments. Other embodiments include fasteners 112 different than screws. FIG. 13B depicts the sealant 1340 in place on the bottom of the junction box 1300. In some embodiments, the housing 1302 includes a bottom inner ridge 1360 and a bottom outer ridge 1362 configured to maintain a spacing between the bottom of the housing 1302 and structure to which the housing 1302 is anchored. In some embodiments, the bottom inner ridge 1360 and the bottom outer ridge 1362 are sized to allow a particular amount of compression on the sealant 1340 so that the sealant 1340 is not over-compressed.

In some embodiments, the bottom inner ridge 1360 provides stiffening of the bottom of the housing 1302. In some embodiments, the bottom outer ridge 1362 also provides stiffening of the bottom of the housing 1302. In some embodiments, the bottom inner ridge 1360 and/or the bottom outer ridge 1362 provide enough stiffening of the bottom of the housing 1302 so that a compression ring 118 is not needed. In other embodiments, the bottom inner ridge 1360 and/or the bottom outer ridge 1362 provide some stiffening and a compression ring 118 provides additional stiffening of the bottom of the housing 1302. In some embodiments, the bottom inner ridge 1360 and/or the bottom outer ridge 1362 provide stiffening and support for a drill zone within a central area within the bottom inner ridge 1360.

FIG. 13C depicts the fasteners 112 penetrating the sealant 1340. FIG. 13D is a bottom perspective view of the junction box 1300 of FIG. 13A with the sealant 1340 and screws installed where the sealant 1340 is compressed and flattened against a structure, according to various embodiments. In some embodiments, the size of the bottom inner and outer ridges 1360, 1362, when the housing 1302 of the junction box 1300 is anchored to a structure compresses the sealant 1340 a particular amount.

FIG. 13E is a side view and a side section view of the housing 1302 junction box 1300 of FIG. 13A with the sealant 1340 and fasteners 112 installed where the sealant 1340 is flattened against a structure, according to various embodiments. The sealant 1340 is depicted under the outer fasteners 112 and between the bottom inner and outer ridges 1360, 1362.

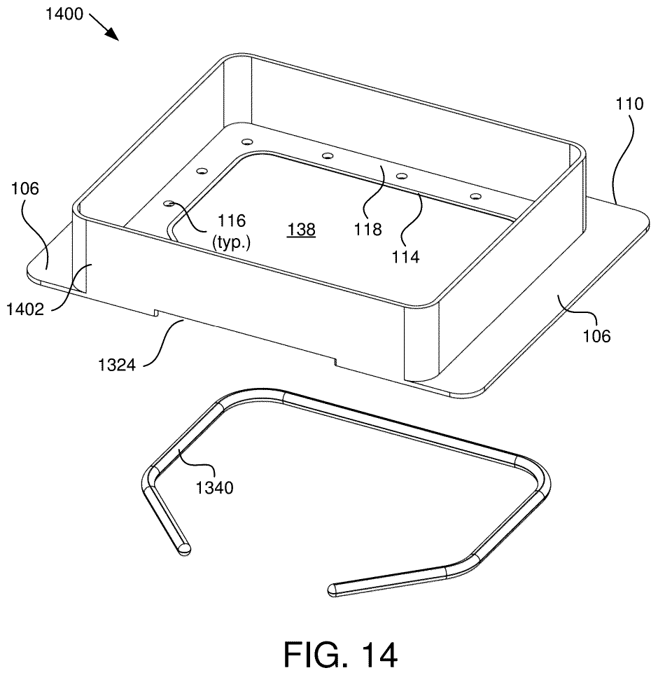

FIG. 14 is a top perspective view of a housing 1402 of a junction box 1400 with side flashing 106 and a perspective view of a sealant 1340 to be mounted to the bottom of the housing 1402 of the junction box 1400, according to various embodiments. The junction box 1400 in FIG. 14 is similar to the junction box 1300 in FIG. 13A except that the junction box 1400 in FIG. 14 includes side flashing 106.

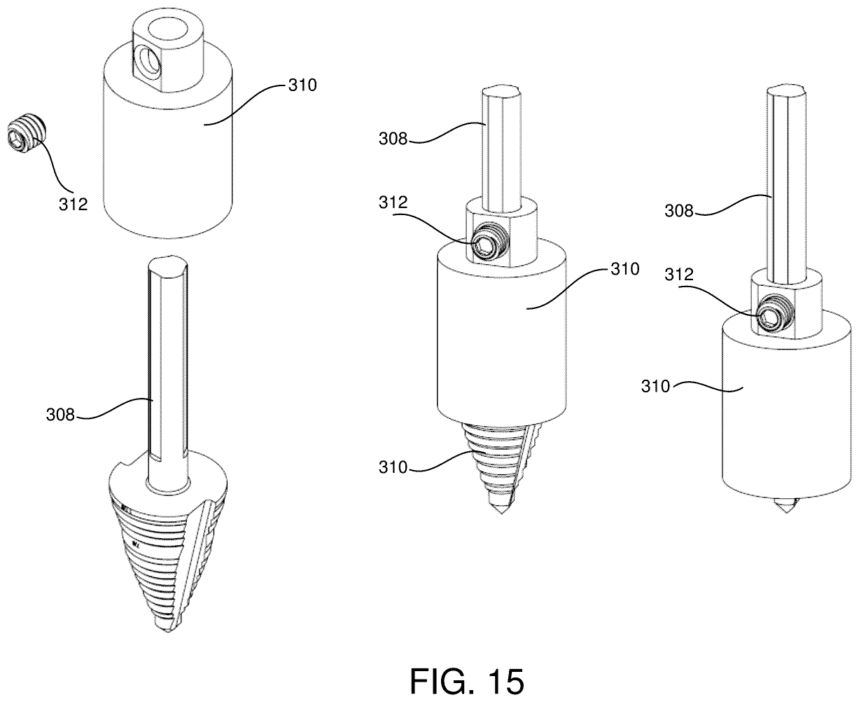

FIG. 15 is an exploded side perspective view of a step drill bit 308 and a depth guide 310, a side perspective view of the step drill bit 308 with the depth guide 310 in a first position, and a side perspective view of the step drill bit 308 with the depth guide 310 in a second position, according to various embodiments. The left side depicts a step drill bit 308 separate from the depth guide 310. The depth guide 310 includes a hollow portion that fits over the step drill bit 308. The depth guide 310 can be raised and lowered using a set screw 312 so that a bottom of the depth guide 310 is even with a particular step size on the step drill bit 308.

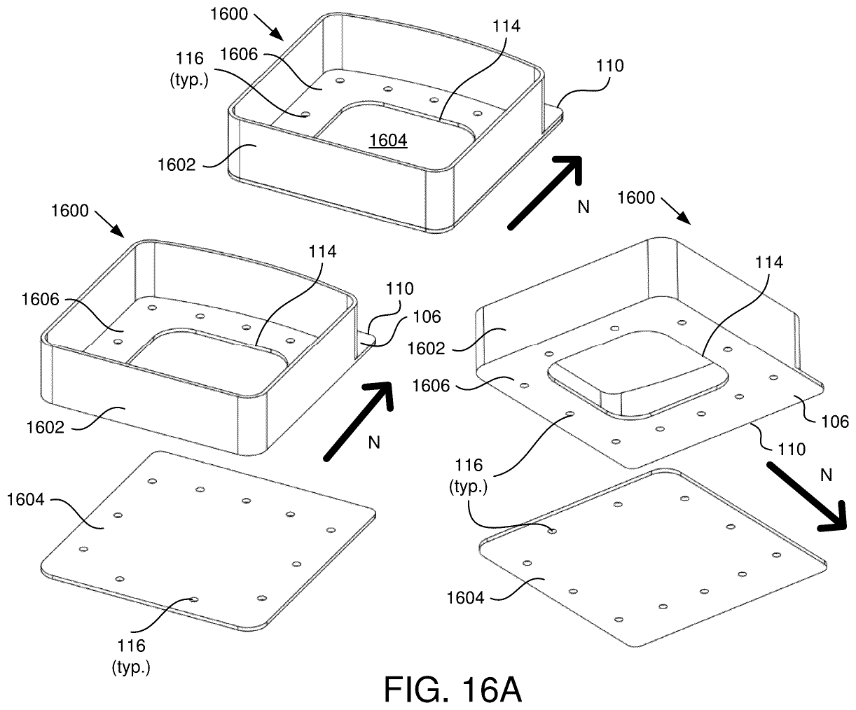

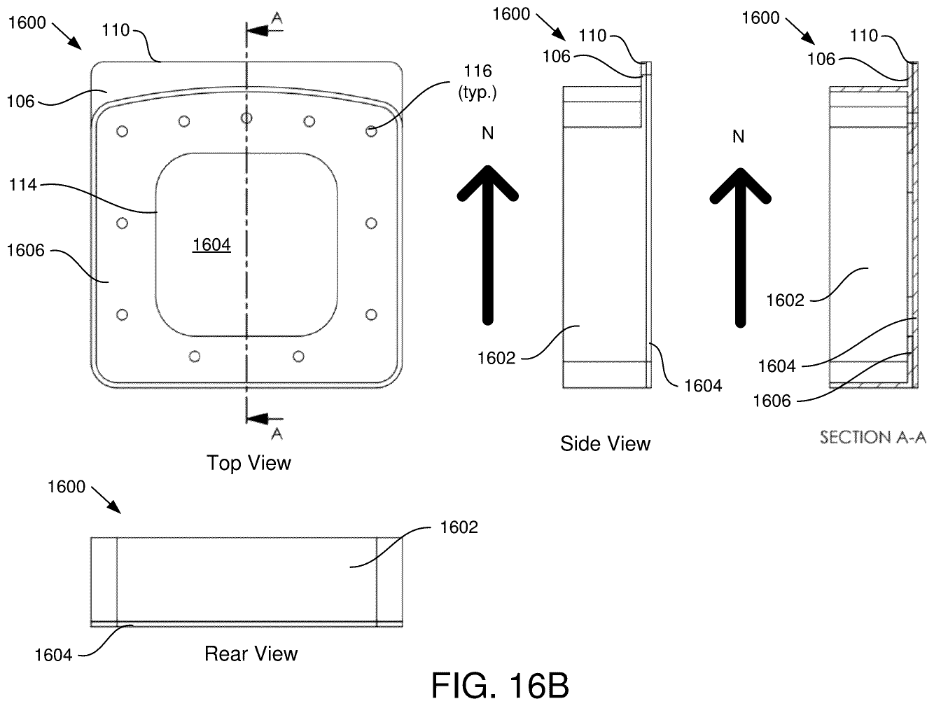

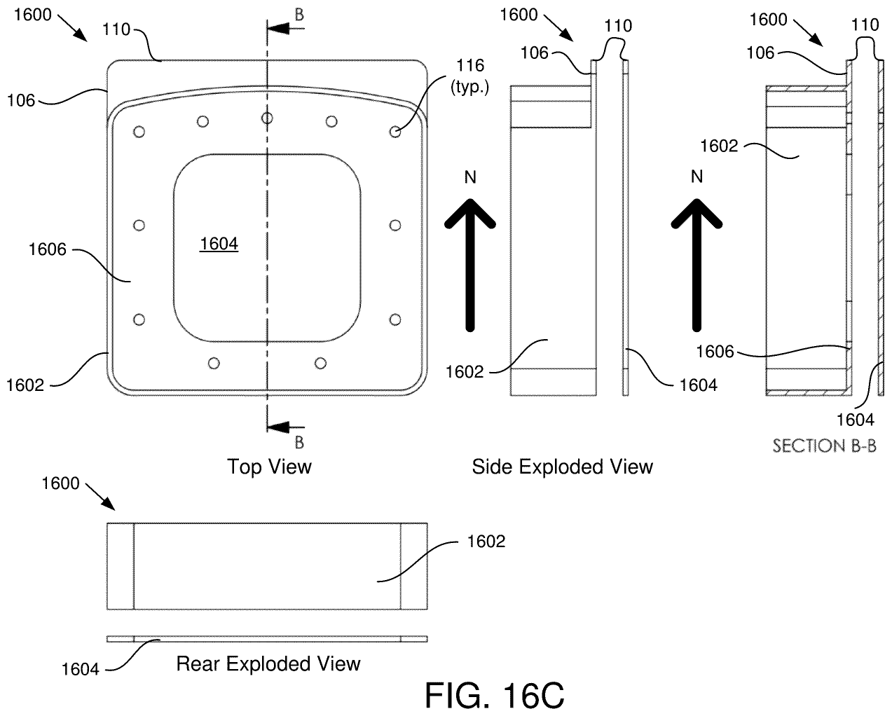

FIG. 16A is a top perspective view of a housing 1602 of a junction box 1600 with full bottom plate 1604 installed, a top perspective view of the junction box 1600 with the full bottom plate 1604 removed, and a bottom perspective view of the junction box 1600 with the full bottom plate 1604 removed, according to various embodiments. FIG. 16B is a top view, a side view, a section view, and a rear view of the junction box 1600 of FIG. 16A, according to various embodiments. FIG. 16C is a top view, a side exploded view, a section exploded view, and a rear exploded view of the junction box 1600 of FIG. 16A, according to various embodiments.

The housing 1602 of the junction box 1600 depicted in FIGS. 16A-C include a full bottom plate 1604 that covers the entire bottom of the junction box 1600. The junction box 1600 includes a hole in the bottom and the full bottom plate 1604 covers the hole as well as areas of the housing bottom 1606 of the housing 1602 surrounding the hole. In some embodiments, fastener openings 116 in the plate correspond to fastener openings 116 in the housing bottom 1606 of the junction box 1600. In some embodiments, edges of the hole in the housing bottom 1606 become a drill zone marking 114. In some embodiments, a sealant (not shown) is placed between the full bottom plate 1604 and the housing bottom 1606 of the junction box 1600. In some embodiments, the fastener openings 116 correspond to the sealant. In some embodiments, an additional sealant (not shown) is placed under the full bottom plate 1604 to seal between the structure and the full bottom plate 1604. In some embodiments, this second sealant corresponds to the fastener openings 116. In some embodiments, the full bottom plate 1604 has a thickness that complies with a local fire rating. In other embodiments, the thickness of the full bottom plate 1604 is sized so that tabs 706 of a conduit connector 704 snap into a hole in the full bottom plate 1604.

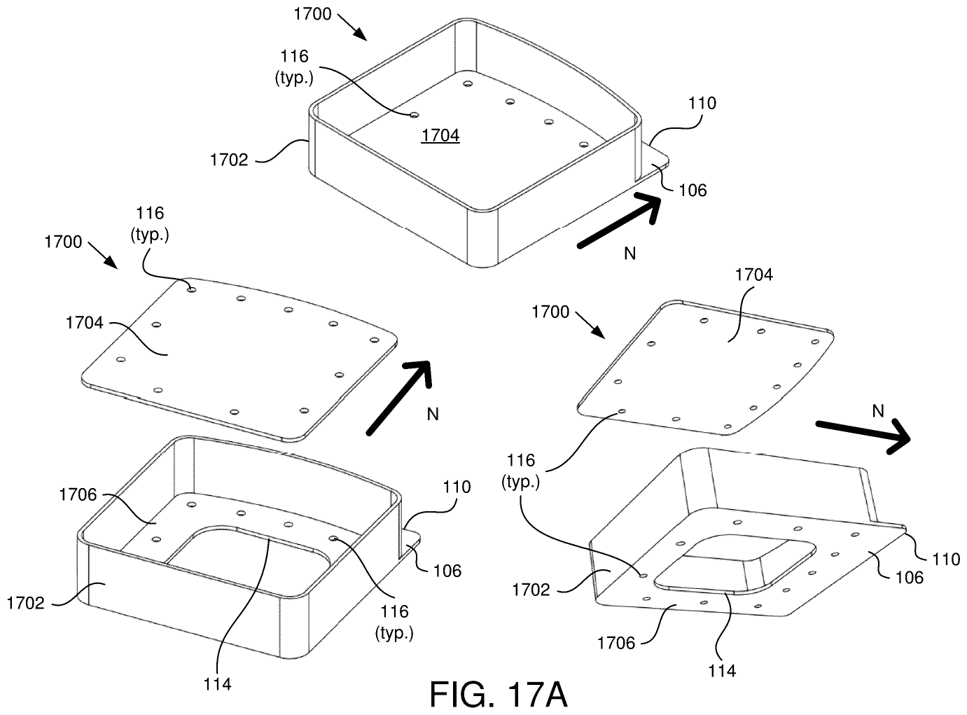

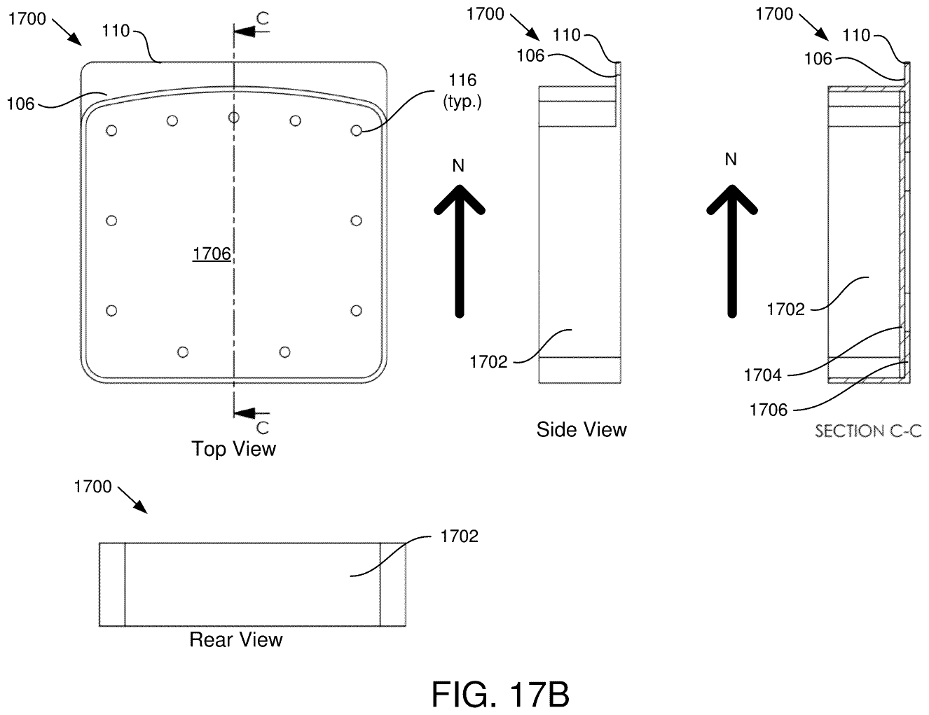

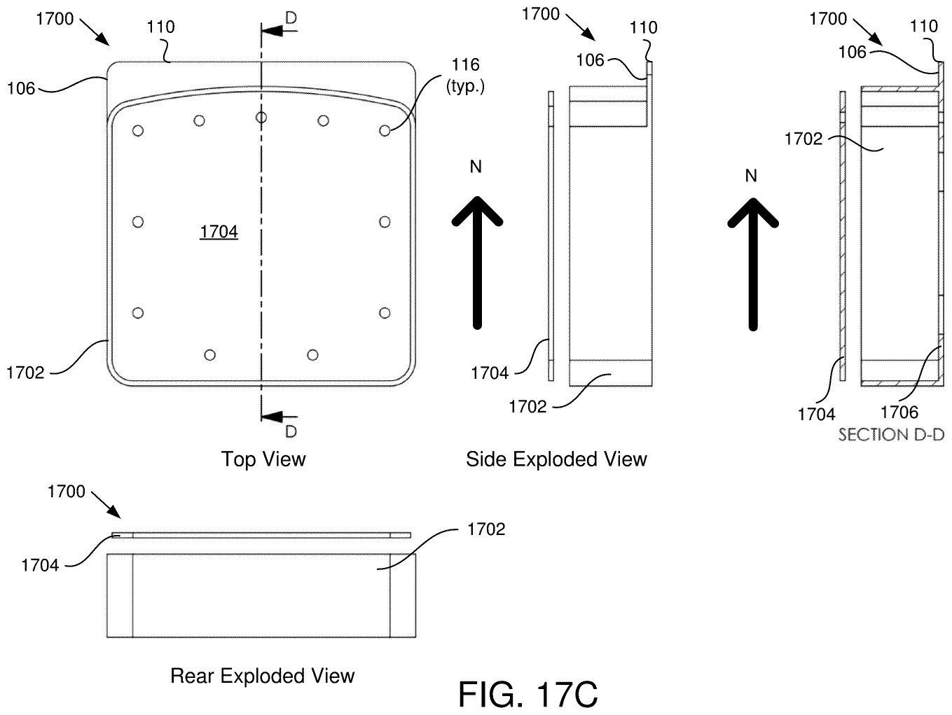

FIG. 17A is a top perspective view of a housing 1702 of a junction box 1700 with an interior plate 1704 installed in the junction box 1700, a top perspective view of the junction box 1700 with the interior plate 1704 removed, and a bottom perspective view of the junction box 1700 with the interior plate 1704 removed, according to various embodiments. FIG. 17B is a top view, a side view, a section view, and a rear view of the housing 1702 of the junction box 1700 of FIG. 17A, according to various embodiments. FIG. 17C is a top view, a side exploded view, a section exploded view, and a rear exploded view of the housing 1702 of the junction box 1700 of FIG. 17A, according to various embodiments.

The junction box 1700 depicted in FIGS. 17A-C includes an interior plate 1704 configured to fit into the junction box 1700 from a top side where the interior plate 1704 is positioned over a hole in the bottom 1706 of the junction box 1700. The bottom 1706 of the junction box 1700 is between the interior plate 1704 and a structure to which the junction box 1700 is anchored. In some embodiments, the interior plate 1704 covers the entire bottom of the junction box 1700. In other embodiments, the interior plate 1704 fits in a recess at the bottom 1706 of the junction box 1700, which may serve to hold the interior plate 1704 in place with respect to the junction box 1700. In some embodiments, fastener openings 116 in the interior plate 1704 correspond to fastener openings 116 in the bottom 1706 of the junction box 1700. In some embodiments, a sealant (not shown) is placed between the interior plate 1704 and the bottom 1706 of the junction box 1700. In some embodiments, the fastener openings 116 correspond to the sealant. In some embodiments, an additional sealant is placed under the bottom 1706 of the junction box 1700 to seal between the structure and the junction box 1700. In some embodiments, this second sealant corresponds to the fastener openings 116. In some embodiments, the interior plate 1704 includes a drill zone marking 114, which is placed interior to the fastener openings 116.

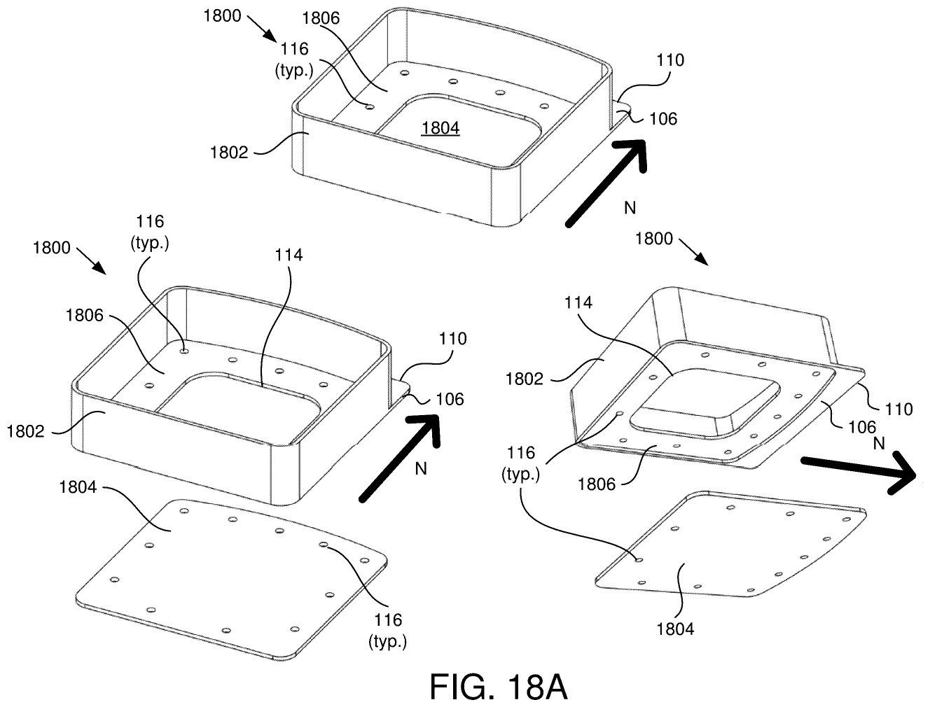

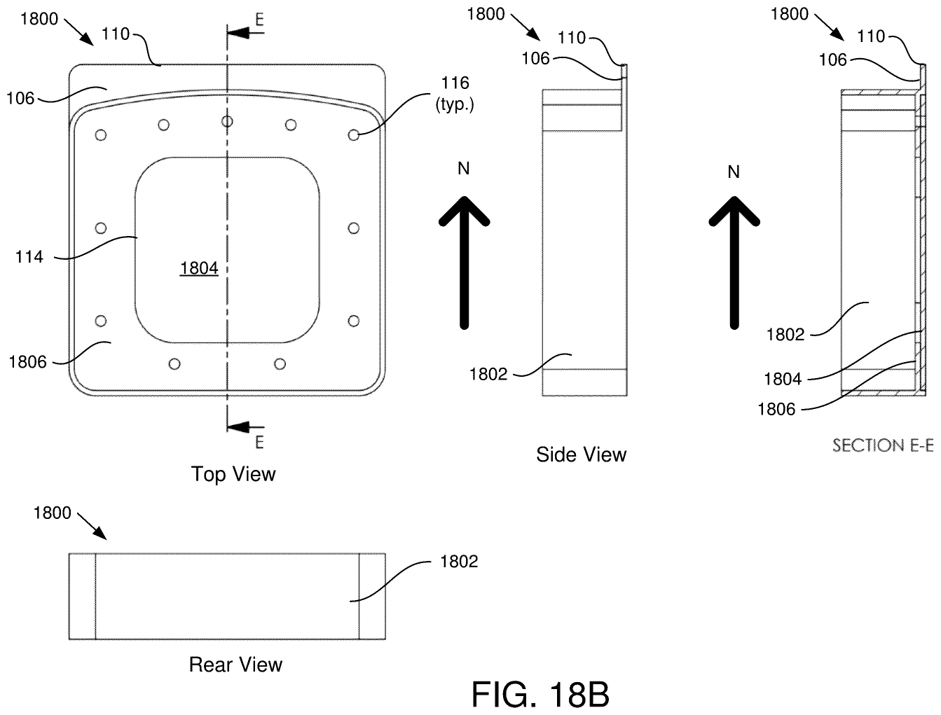

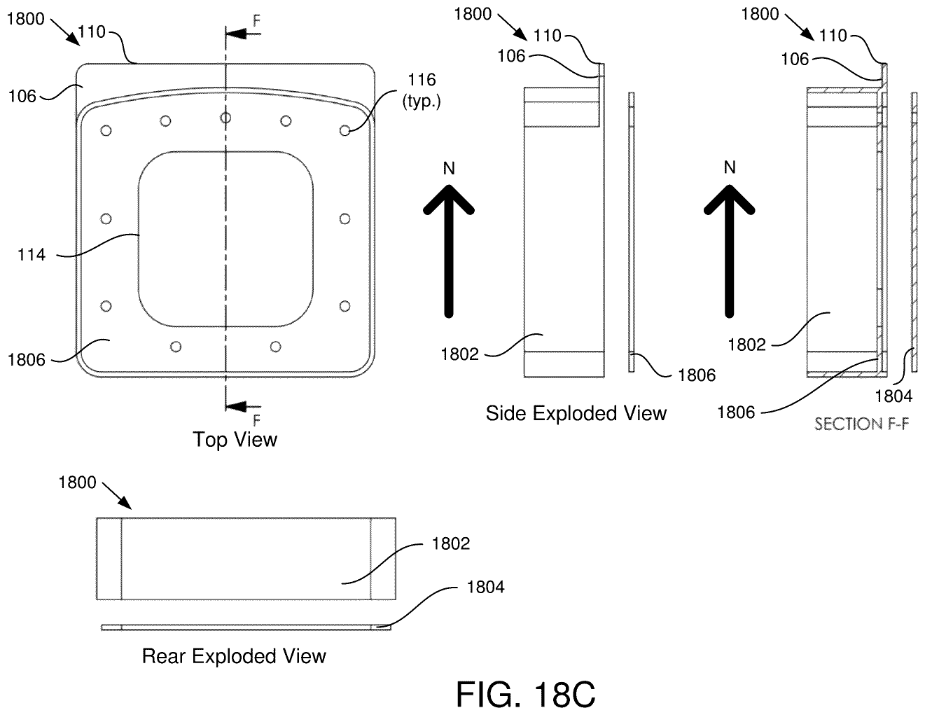

FIG. 18A is a top perspective view of a housing 1802 of a junction box 1800 with partial bottom plate 1804 installed in a cavity of the bottom 1806 of the housing 1802 of the junction box 1800, a top perspective view of the housing 1802 of the junction box 1800 with the partial bottom plate 1804 removed, and a bottom perspective view of the housing 1802 of the junction box 1800 with the partial bottom plate 1804 removed, according to various embodiments. FIG. 18B is a top view, a side view, a section view, and a rear view of the housing 1802 of the junction box 1800 of FIG. 18A, according to various embodiments. FIG. 18C is a top view, a side exploded view, a section exploded view, and a rear exploded view of the housing 1802 of the junction box 1800 of FIG. 18A, according to various embodiments.

The junction box 1800 depicted in FIGS. 18A-C include a partial bottom plate 1804 that fits in a recess in the bottom 1806 of the junction box 1800. The junction box 1800 includes a hole in the bottom 1806 and the partial bottom plate 1804 covers the hole as well as areas of the bottom 1806 surrounding the hole within the recess. In some embodiments, edges of a hole in the bottom 1806 of the housing 1802 form a drill zone marking 114 of a drill zone. In other embodiments, the recess at the bottom 1806 of the housing 1802 of the junction box 1800 serves to hold the partial bottom plate 1804 in place with respect to the housing 1802. In some embodiments, fastener openings 116 in the partial bottom plate 1804 correspond to fastener openings 116 in the bottom 1806 of the housing 1802. In some embodiments, a sealant (not shown) is placed between the partial bottom plate 1804 and the bottom 1806 of the housing 1802. In some embodiments, the fastener openings 116 correspond to the sealant. In some embodiments, an additional sealant (not shown) is placed under the partial bottom plate 1804 to seal between the structure and the partial bottom plate 1804. In some embodiments, this second sealant corresponds to the fastener openings 116.

In some embodiments, the full bottom plate 1604, the interior plate 1704, and the partial bottom plate 1804 are available in different thicknesses and/or different materials to provide different fire ratings to meet local fire rating standards and/or to provide different amounts of stiffening of the bottom of the junction boxes 1600, 1700, 1800. In other embodiments, the full bottom plate 1604, the interior plate 1704, and the partial bottom plate 1804 are available with different drill patterns 244, 444, 644 or with a drill pattern center points 242. In other embodiments, the full bottom plate 1604, the interior plate 1704, and the partial bottom plate 1804 are available in a metal and in a non-metallic material.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A junction box comprising:
a housing comprising a plurality of sides and a bottom, the plurality of sides and the bottom comprising a housing material, the housing material fabricated from a non-metallic material; and
a drill pattern in a side of the plurality of side and/or the bottom, the drill pattern comprising a recess indicating a location for creating a hole through the housing,
wherein a thickness of the housing material under the drill pattern is sized to meet a fire rating standard applicable to a location where the junction box is installed.

2. The junction box of claim 1, wherein the drill pattern is a first drill pattern and the recess is a first recess and further comprising a second drill pattern positioned on a side of the housing opposite the first drill pattern, the second drill pattern comprising a second recess indicating a location for creating a hole through the housing, the second recess aligned with the first recess, wherein the thickness of the housing material between the first recess and the second recess is sized to meet the fire rating standard applicable to the location where the junction box is installed.

3. The junction box of claim 2, wherein the first drill pattern and/or the second drill pattern comprise a plurality of recesses indicative of sizes of holes through the housing, each hole size corresponding to a size of a conduit coupling, wherein the thickness of the housing material between the plurality of recesses of the first and/or the second drill patterns is sized to meet the fire rating standard applicable to the location where the junction box is installed.

4. The junction box of claim 2, wherein the first drill pattern and/or the second drill pattern comprise a center recess sized as a drill guide, the drill guide providing a location for a drill bit used to create the hole through the housing, the center recess centered within the first and/or second recesses.

5. The junction box of claim 2, wherein the side of the plurality of sides and/or the bottom comprising the first drill pattern and/or the second drill pattern comprises a drill zone marking, the drill zone marking indicative of locations on the side of the plurality of sides and/or the bottom suitable for penetrating the housing.

6. The junction box of claim 5, wherein the drill zone marking is on the bottom of the housing and the drill zone marking is within a plurality of fastener openings, each fastener opening of the plurality of fastener openings configured for a fastener to anchor the junction box to a roof of a structure.

7. The junction box of claim 5, wherein the housing is configured to mount to a roof of a structure and the bottom of the housing comprises an exterior side, wherein the exterior side of the bottom comprises a sealant positioned exterior to the drill zone marking, the sealant configured to prevent liquid from accessing a hole through the housing within an area within the drill zone marking and/or through the roof of the structure.

8. The junction box of claim 5, wherein the housing is configured to mount to a roof of a structure and wherein the housing further comprises a flashing extending along a plane parallel to an exterior side of the bottom in a direction away from the housing.

9. The junction box of claim 8, wherein the flashing comprises a groove positioned between a sealant positioned between an edge of the flashing and the drill zone marking, the groove sized as a capillary break to prevent liquid entering between the edge of the flashing and the roof by way of capillary action from moving past the groove.

10. The junction box of claim 2, wherein the side of the plurality of sides and/or the bottom comprising the first drill pattern and/or the second drill pattern comprises a plurality of first drill patterns and/or second drill patterns.

11. The junction box of claim 10, wherein the side of the plurality of sides and/or the bottom comprising the plurality of first drill patterns and/or the second drill patterns comprises a drill zone marking, the drill zone marking indicative of locations on the side of the plurality of sides and/or the bottom suitable for penetrating the housing.

12. The junction box of claim 1, wherein the housing is configured to mount to a sloped roof of a structure and wherein the housing comprises one or more weep holes through the housing positioned on a downslope side of the housing, the one or more weep holes extending on the downslope side a distance from the bottom of the housing.

13. The junction box of claim 1, wherein the non-metallic material of the housing comprises a plastic material, a polycarbonate material, a polyvinyl chloride (“PVC”) material, an acrylonitrile butadiene styrene (ABS) material, acrylonitrile styrene and polycarbonate blend (ASA+PC) material, and/or a polycarbonate and ABS blend (PC+ABS) material.

14. A junction box comprising:
a housing comprising a plurality of sides and a bottom, the plurality of sides and the bottom comprising a housing material, the housing material fabricated from a non-metallic material;
one or more drill patterns in a side of the plurality of side and/or the bottom, each of the one or more drill patterns comprising a recess indicating a location for creating a hole through the housing; and
a drill zone marking on a side of the plurality of sides and/or the bottom surrounding the one or more drill patterns, the drill zone marking indicative of locations on the side of the plurality of sides and/or the bottom suitable for penetrating the housing,
wherein a thickness of the housing material under the one or more drill patterns is sized to meet a fire rating standard applicable to a location where the junction box is installed.

15. The junction box of claim 14, wherein the one or more drill patterns are one or more first drill patterns and the recess of the one or more drill patterns is a first recess and further comprising one or more second drill patterns positioned on a side of the housing opposite the one or more first drill patterns, the one or more second drill patterns each comprising a second recess indicating a location for creating a hole through the housing, each of the one or more second recesses aligned with a corresponding first recess, wherein the thickness of the housing material between each of the first recesses and the corresponding second recesses is sized to meet the fire rating standard applicable to the location where the junction box is installed.

16. The junction box of claim 15, wherein:
the one or more first drill patterns and/or the one or more second drill patterns comprise a plurality of recesses indicative of sizes of holes through the housing, each hole size corresponding to a size of a conduit coupling, wherein the thickness of the housing material between the plurality of recesses of the one or more first drill patterns and/or the one or more second recesses is sized to meet the fire rating standard applicable to the location where the junction box is installed; and/or
the one or more first drill patterns and/or the one or more second drill patterns comprise a center recess sized as a drill guide, the drill guide providing a location for a drill bit used to create the hole through the housing, the center recess centered within the first and/or second recesses.

17. The junction box of claim 15, wherein:
the drill zone marking is on the bottom of the housing and the drill zone marking is within a plurality of fastener openings, each fastener opening of the plurality of fastener openings configured for a fastener to anchor the junction box to a roof of a structure;
the housing is configured to mount to a roof of a structure and the bottom of the housing comprises an exterior side, wherein the exterior side of the bottom comprises a sealant positioned exterior to the drill zone marking, the sealant configured to prevent liquid from accessing a hole through the housing within an area within the drill zone marking and/or through the roof of the structure; and/or
wherein the housing further comprises a flashing extending along a plane parallel to the exterior side of the bottom in a direction away from the housing.

18. The junction box of claim 17, wherein the flashing comprises a groove positioned between a sealant positioned between an edge of the flashing and the drill zone marking, the groove sized as a capillary break to prevent liquid entering between the edge of the flashing and the roof by way of capillary action from moving past the groove.

19. The junction box of claim 14, wherein the housing is configured to mount to a sloped roof of a structure and wherein the housing comprises one or more weep holes through the housing positioned on a downslope side of the housing, the one or more weep holes extending on the downslope side a distance from the bottom of the housing.

20. A junction box comprising:
a housing comprising a plurality of sides and a bottom, the plurality of sides and the bottom comprising a housing material, the housing material fabricated from a non-metallic material, the housing configured to mount to a sloped roof of a structure;
one or more first drill patterns in a side of the plurality of side and/or the bottom, each of the one or more drill patterns comprising a first recess indicating a location for creating a hole through the housing;
one or more second drill patterns positioned on a side of the housing opposite the one or more first drill patterns, the one or more second drill patterns each comprising a second recess indicating a location for creating a hole through the housing, each of the one or more second recesses aligned with a corresponding first recess;
a drill zone marking on a side of the plurality of sides and/or the bottom surrounding the one or more drill patterns, the drill zone marking indicative of locations on the side of the plurality of sides and/or the bottom suitable for penetrating the housing; and
flashing extending along a plane parallel to an exterior side of the bottom in a direction away from the housing,
wherein a thickness of the housing material between each of the first recesses and the corresponding second recesses is sized to meet a fire rating standard applicable to a location where the junction box is installed.
